(19) United States
(12) Patent Application Publication
(10) Pub. No.: US 2017/0371524 A1
(43) Pub. Date: Dec. 28, 2017

(54) INFORMATION PROCESSING APPARATUS, PICTURE PROCESSING METHOD, AND PROGRAM

(71) Applicant: SONY CORPORATION, TOKYO (JP)

(72) Inventors: TAKUYA FUJITA, KANAGAWA (JP); ATSUSHI NODA, TOKYO (JP)

(21) Appl. No.: 15/540,095

(22) PCT Filed: Jan. 28, 2016
(86) PCT No.: PCT/JP2016/052453

§ 371 Date: Jun. 27, 2017

(30) Foreign Application Priority Data
Feb. 4, 2015 (JP) 2015-019998

(51) Int. Cl. G06F 3/0484; G06F 17/30

(52) U.S. Cl. CPC G06F 3/04845; G06F 17/30047

(57) ABSTRACT

[Object] To provide an information processing apparatus, a picture processing method, and a program that enable control of display of content itself based on a relationship between the content and a user. [Solution] The information processing apparatus includes a display control unit that controls display of acquired content depending on the acquired content, metadata of the content, and information indicating a relationship between the content and a user.

### TECHNICAL FIELD

The present disclosure relates to an information processing apparatus, a picture processing method, and a program.

### BACKGROUND ART

Recently, people have become to encounter content such as a large amount of pictures and music every day. Also, people encounter content in various situations. Accordingly, there is a demand for a technology for providing content more suited to situations in which people encounter content.

For example, Patent Literature 1 below discloses a technology for setting priorities for a plurality of pieces of information provided in a plurality of frames having different sizes included in a menu screen on the basis of a past usage history and allocating frames depending on priorities of the information.

### CITATION LIST

### Patent Literature

Patent Literature 1: JP 2001-125919A

### DISCLOSURE OF INVENTION

### Technical Problem

However, the technology disclosed in Patent Literature 1 above can merely provide a plurality of pieces of information in sizes depending on priority order. Considering that relationships between a person and content, such as the purpose of viewing the content of the person, the timing of viewing the content and an environment in which the person views the content, have diversified in recent years, it is desirable to enable control of display of the content itself based on a relationship between the content and a user.

### Solution to Problem

According to the present disclosure, there is provided an information processing apparatus including a display control unit that controls display of acquired content depending on the acquired content, metadata of the content, and information indicating a relationship between the content and a user.

In addition, according to the present disclosure, there is provided a picture processing method including controlling display of acquired content by a processor, depending on the acquired content, metadata of the content, and information indicating a relationship between the content and a user.

In addition, according to the present disclosure, there is provided a program for causing a computer to function as a display control unit that controls display of acquired content depending on the content, metadata of the content, and information indicating a relationship between the content and a user.

### Advantageous Effects of Invention

As described above, according to the present disclosure, it is possible to enable control of display of content itself based on a relationship between the content and a user. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an information processing apparatus according to the present embodiment.

FIG. 2 is a block diagram illustrating an example of a logical configuration of the information processing apparatus according to the present embodiment.

FIG. 3 is a diagram for describing an example of a content analysis process according to the present embodiment.

FIG. 4 is a diagram for describing an example of a process of generating a display picture according to the present embodiment.

FIG. 5 is a diagram for describing an example of a process of generating a display picture according to the present embodiment.

FIG. 6 is a diagram for describing an example of a process of generating a display picture according to the present embodiment.

FIG. 7 is a diagram for describing an example of a process of generating a display picture according to the present embodiment.

FIG. 8 is a diagram for describing an example of a process of generating a display picture according to the present embodiment.

FIG. 9 is a diagram for describing an example of a process of generating a display picture according to the present embodiment.

FIG. 10 is a diagram for describing an example of a process of generating a display picture according to the present embodiment.

FIG. 11 is a diagram for describing an example of a process of generating a display picture according to the present embodiment.

FIG. 12 is a diagram for describing an example of a process of generating a display picture according to the present embodiment.

FIG. 13 is a diagram for describing an example of a process of generating a display picture according to the present embodiment.

FIG. 14 is a diagram for describing an example of a process of generating a display picture according to the present embodiment.

FIG. 15 is a diagram for describing an example of a process of generating a display picture according to the present embodiment.

FIG. 16 is a diagram for describing an example of a process of generating a display picture according to the present embodiment.

FIG. 17 is a diagram for describing an example of a process of generating a display picture according to the present embodiment.

FIG. 18 is a diagram for describing an example of a process of generating a display picture according to the present embodiment.

FIG. 19 is a diagram for describing an example of a process of generating a display picture according to the present embodiment.

FIG. 20 is a diagram for describing an example of a process of generating a display picture according to the present embodiment.

FIG. 21 is a diagram for describing an example of a process of generating a display picture according to the present embodiment.

FIG. 22 is a diagram for describing an example of a process of generating a display picture according to the present embodiment.

FIG. 23 is a diagram for describing an example of a process of generating a display picture according to the present embodiment.

FIG. 24 is a diagram for describing an example of a process of generating a display picture according to the present embodiment.

FIG. 25 is a diagram for describing an example of a setting screen with respect to the process of generating a display picture according to the present embodiment.

FIG. 26 is a flowchart illustrating an example of a flow of a display picture output process performed in the information processing apparatus according to the present embodiment.

FIG. 27 is a diagram for describing an example of a manipulation method according to a modified example according to the present embodiment.

FIG. 28 is a diagram for describing an example of a manipulation method according to the present modified example.

FIG. 29 is a diagram for describing an example of a manipulation method according to the present modified example.

FIG. 30 is a diagram for describing an example of a manipulation method according to the present modified example.

FIG. 31 is a diagram for describing an example of a manipulation method according to the present modified example.

FIG. 32 is a diagram for describing an example of a manipulation method according to the present modified example.

FIG. 33 is a diagram for describing an example of a manipulation method according to the present modified example.

FIG. 34 is a diagram for describing an example of a manipulation method according to the present modified example.

FIG. 35 is a diagram for describing an example of a manipulation method according to the present modified example.

FIG. 36 is a diagram for describing an example of a manipulation method according to the present modified example.

FIG. 37 is a diagram for describing an example of a manipulation method according to the present modified example.

FIG. 38 is a diagram for describing an example of a manipulation method according to the present modified example.

FIG. 39 is a diagram for describing an example of a manipulation method according to the present modified example.

FIG. 40 is a diagram for describing an example of a manipulation method according to the present modified example.

FIG. 41 is a diagram for describing an example of a manipulation method according to the present modified example.

FIG. 42 is a diagram for describing an example of a manipulation method according to the present modified example.

FIG. 43 is a diagram for describing an example of a manipulation method according to the present modified example.

FIG. 44 is a block diagram illustrating an example of a hardware configuration of the information processing apparatus according to the present embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Description will be given in the following order.
1. Overview
2. Configuration Example
3. Operation Processing Example
4. Modified Example
5. Hardware Configuration Example
6. Conclusion

### 1. Overview

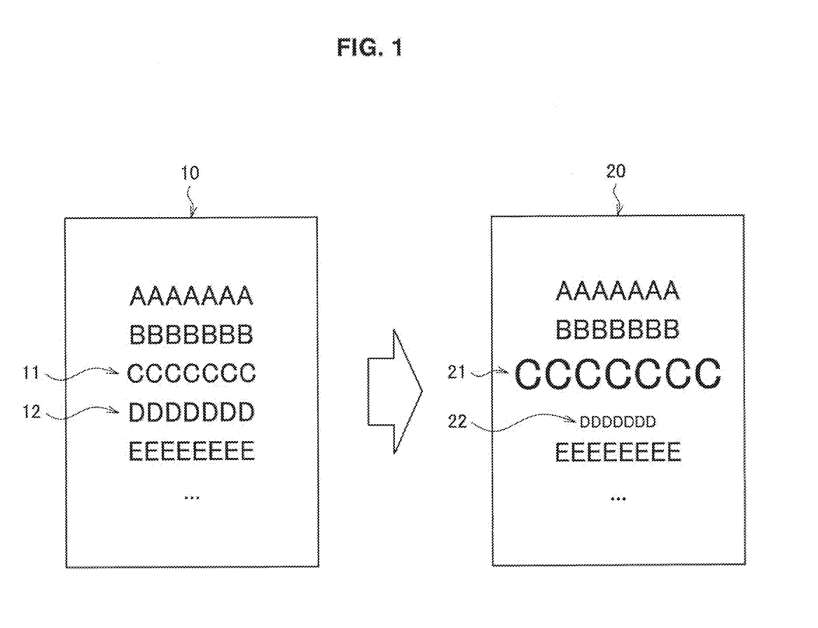

First of all, an overview of an information processing apparatus according to an embodiment of the present disclosure will be described with reference to FIG. 1.

FIG. 1 is a diagram for describing an overview of the information processing apparatus according to the present embodiment. FIG. 1 illustrates an example of a display picture generated from content by the information processing apparatus. A symbol 10 indicates content and a symbol 20 indicates a display picture. In the present embodiment, pictures (still pictures/moving pictures), web pages, character strings, sounds or the like are referred to as content. Also, pictures drawn on the basis of content are also referred to as display pictures. In a general apparatus, content is drawn as it is and thus a display picture is generated. In contrast, the information processing apparatus according to the present embodiment generates a display picture by converting and drawing all or part of content. For example, in the example illustrated in FIG. 1, a character string 11 in a content 10 is enlarged to a character string 21 in a display picture 20. Also, a character string 12 in the content 10 is reduced to a character string 22 in the display picture 20.

The information processing apparatus according to the present embodiment generates a display picture on the basis of the details of content and information indicating a relationship between the content and a user. The relationship between the content and the user may be conceived to have various forms. Hereinafter, a relationship between content and a user will be referred to as a context and the information indicating a relationship between content and a user will be referred to as context information. The information processing apparatus according to the present embodiment generates a display picture by converting content on the basis of the details of the content and context information. A user can view a display picture suited to the details of content and his/her context, and thus user convenience is improved.

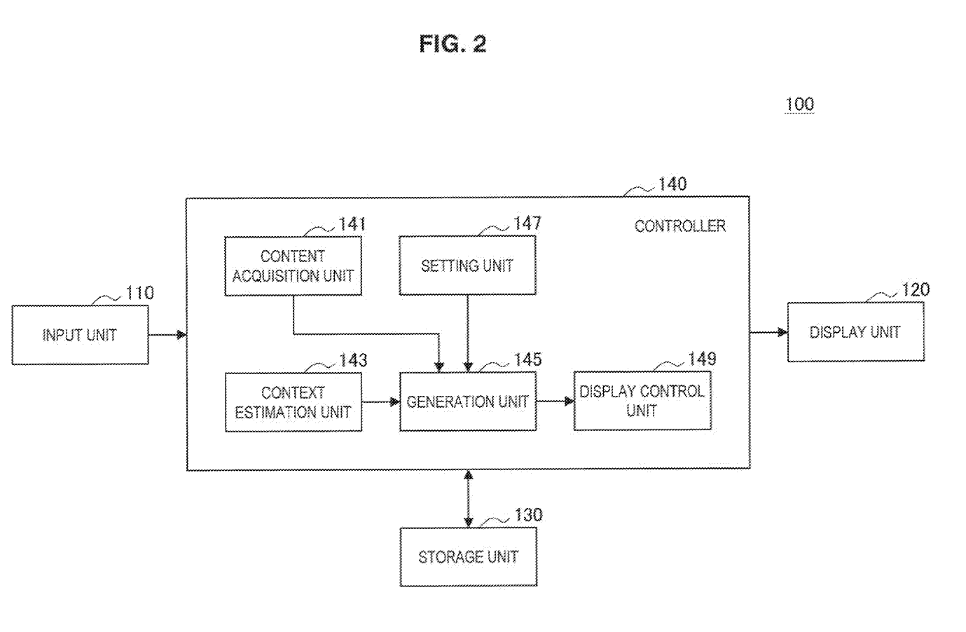

The overview of the information processing apparatus according to the present embodiment has been described above. Next, a configuration example of the information processing apparatus according to the present embodiment will be described with reference to FIGS. 2 to 7.

### 2. Configuration Example

FIG. 2 is a block diagram illustrating an example of a logical configuration of the information processing apparatus according to the present embodiment. As illustrated in FIG. 2, an information processing apparatus 100 includes an input unit 110, a display unit 120, a storage unit 130 and a controller 140.

### (1) Input Unit 110

The input unit 110 has a function of receiving input of various types of information. The input unit 110 outputs received input information to the controller 140.

For example, the input unit 110 may include a sensor which detects manipulation and a state of a user. For example, the input unit 110 may be realized by a camera or a stereo camera which has a user or the surroundings of the user as a photographing target. In addition, the input unit 110 may be realized by a microphone, a global positioning system (GPS), an infrared sensor, a beam sensor, a myoelectric sensor, a nerve sensor, a pulse sensor, a body temperature sensor, a temperature sensor, a gyro sensor, an acceleration sensor, a touch sensor or the like. Pictures and sounds acquired by a camera and a microphone may be handled as content. Various types of information may be added to content. For example, Exif information, tagged information and the like may be added to content.

For example, the input unit 110 may include a manipulation unit which detects user manipulation. The input unit 110 may be realized by, for example, a keyboard, a mouse or a touch panel configured in a manner of being integrated with the display unit 120.

For example, the input unit 110 may include a wired/wireless interface. As a wired interface, for example, a connector complying with standards such as universal serial bus (USB) may be conceived. As a wireless interface, for example, a communication apparatus complying with communication standards such as Bluetooth (registered trademark) or Wi-Fi (registered trademark) may be conceived. For example, the input unit 110 may acquire content from other apparatuses such as a personal computer (PC) and a server.

### (2) Display Unit 120

The display unit 120 has a function of displaying various types of information. For example, the display unit 120 may have a function of displaying a display picture generated by the controller 140. The display unit 120 is realized by, for example, a liquid crystal display (LCD) or an organic light-emitting diode (OLED). In addition, the display unit 120 may be realized by a projector which projects a display picture on a projection surface.

### (3) Storage Unit 130

The storage unit 130 has a function of storing various types of information. For example, the storage unit 130 may include a context database (DB) which stores information indicating a correlation between input information and context information. Also, the storage unit 130 may include a conversion rule DB which stores information indicating a correlation between context information and rules for conversion from content to a display picture.

### (4) Controller 140

The controller 140 serves as an arithmetic processing unit and a control device and controls overall operation in the information processing apparatus 100 according to various programs. As illustrated in FIG. 2, the controller 140 functions as a content acquisition unit 141, a context determination unit 143, a generation unit 145, a setting unit 147 and a display control unit 149.

### (4.1) Content Acquisition Unit 141

The content acquisition unit 141 has a function of acquiring content. For example, the content acquisition unit 141 may acquire content input through the input unit 110. The content acquisition unit 141 outputs the acquired content to the generation unit 145.

### (4.2) Context Determination Unit 143

The context determination unit 143 has a function of determining a context. For example, the context determination unit 143 may determine a context on the basis of input information input through the input unit 110 and output context information indicating an estimation result to the generation unit 145. As will be described below, various types of context information may be conceived.

The context information may be information related to properties of a user. A user is a user of the information processing apparatus 100 and a person who views a display picture generated by the information processing apparatus 100. A user may be one person or multiple persons. As user properties, for example, the number of users, whether a user is an adult or a child, a friend relationship, a job, a hobby, a life stage and the like may be conceived. The context determination unit 143 may determine such context information on the basis of information previously input by a user, information written on a social network service (SNS) and the like. When the context information is information related to properties of a user, the user may view a display picture converted depending on his/her properties, for example.

The context information may be information related to the knowledge or preference of a user regarding content. As the knowledge about the content, for example, the number of times a user has encountered the content, and the like may be conceived. As the preference regarding the content, for example, whether the user likes or dislikes the content, and the like may be conceived. The context determination unit 143 may determine such context information on the basis of a past user action history, a purchase history and the like, for example. When the context information is information related to the knowledge or preference of a user regarding content, the user may view a display picture which is adapted to a knowledge level of the user or in which a part the user likes has been emphasized and a part the user dislikes has been converted in a blurred manner, for example.

The context information may be information related to the purpose of viewing content of a user. As the purpose of viewing, for example, a purpose of promoting a conversation, a purpose of recollecting a thing in the past, and the like may be conceived. In addition, as the purpose of viewing, a purpose of learning the details of news articles, scientific books and the like, a purpose of tagging faces, human bodies, specific shapes, animals, plants, artificial structures and the like, a purpose of searching for stations, stores, parking lots, and the like may be conceived. The context determination unit 143 may determine such context information on the basis of voice recognition processing, search words, position information, action information and the like with respect to a user conversation. In addition, the context determination unit 143 may determine context information on the basis of an executed application, a web page type being viewed, or the like. When the context information is information related to the purpose of viewing content of a user, the user may view a display picture converted such that the purpose of the user is accomplished more easily, for example.

The context information may be information related to a region of interest of a user in a display picture. The context determination unit 143 may determine such context information on the basis of a gaze of the user, a position of a mouse pointer, a touch position of a touch sensor, a position of a pointer of a space pointing device or the like. When the context information is information related to a region of interest of a user in a display picture, the user may view a display picture in which the visibility of the region of interest of the user has been improved, for example.

The context information may be sound information based on viewing of a display picture. As sound information based on viewing of a display picture, for example, a sound that a user hears when viewing a display picture may be conceived. As a sound that a user hears, for example, music, an audio book reading voice, a conversation performed with or without viewing the display picture, and the like may be conceived. The context determination unit 143 may determine such context information on the basis of surrounding sound acquired by a microphone, a file name of sound data which is being reproduced, and the like. When the context information is sound information based on viewing of a display picture, a user may view the display picture according to the sound that the user hears.

The context information may be action information based on viewing of a display picture. As action information based on viewing of a display picture, for example, a user's action performed when viewing the display picture may be conceived. For example, searching for a route to a destination, commuting, commuting to school, moving (riding or walking), relaxation, reading, or the like may be conceived as an action of a user. In addition, for action information based on viewing of a display picture, for example, a situation of a user when viewing the display picture may be conceived. For example, as a situation of a user, whether the user is busy, in other words, whether the user can perform a certain action or will have difficulty in performing another action before the current action is finished, or the like may be conceived. The context determination unit 143 may determine such context information on the basis of a user's action, a user's operation and the like, acquired through a sensor. When the context information is action information based on viewing of a display picture, a user may view a display picture according to an action performed himself/herself. Action information may be information related to surrounding people in addition to information related to the user. For example, when it is detected that a person next to the user looks into a display picture, a photo may be displayed smaller when the person is a stranger and in contrast may be displayed larger when the person is a friend.

The context information may be information related to a positional relationship between the display unit 120 displaying a display picture and a user. As information related to the positional relationship, for example, the distance and angle between the display unit 120 and the user, and the like may be conceived. The context determination unit 143 may determine such context information, for example, on the basis of a photographing result according to a stereo camera having the user as a photographing target, and the like. When the context information is information related to a positional relationship between the display unit 120 and a user, the user may view a display picture which has been converted such that visibility is improved depending on the positional relationship.

The context information may be information indicating characteristics related to the display unit 120 which displays a display picture. As information indicating characteristics related to the display unit 120, for example, the size and resolution of the display unit 120, a type of apparatus on which the display unit 120 is mounted, and the like may be conceived. The context determination unit 143 may determine such context information, for example, on the basis of information previously stored in the storage unit 130. When the context information is information indicating characteristics related to the display unit 120 which displays a display picture, a user may view a display picture which has been converted into a display size suitable for the characteristics related to the display unit 120.

The context information may be information related to an environment of a user. As an environment of a user, for example, the position of the user, the weather, the surrounding brightness, the temperature and the like may be conceived. The context determination unit 143 may determine such context information on the basis of a detection result of a senor such as a GPS, a temperature sensor or a hygrometer. When the context information is information related to an environment of a user, the user may view a display picture displayed with a display setting such as a luminance and a resolution suitable for the environment.

Examples of the context information have been described above. The context information may include two or more pieces of the aforementioned information.

### (4.3) Generation Unit 145

The generation unit 145 has a function of generating a display picture depending on the details of acquired content and context information. Here, the details of the content mean the content itself and metadata of the content. The metadata of the content refers to all information included in the content and may include, for example, a content type such as picture/sound/moving picture, information on an object included in the content, and a time and a place at which the content was photographed when the content is a picture. The metadata may have been previously added to the content or may be extracted from the content according to picture analysis, picture recognition, statistics processing, learning or the like. For example, the generation unit 145 may generate a display picture in which content has been converted on the basis of the content acquired by the content acquisition unit 141, metadata acquired by analyzing the content, and context information determined by the context determination unit 143. Thereafter, the generation unit 145 outputs the generated display picture to the display control unit 149.

For example, the generation unit 145 may change the display form of the content or change some or all objects included in the content depending on the acquired content, the metadata of the content and the context information. Hereinafter, changing the display form of the content and changing some or all objects included in the content will be described in detail.

For example, the generation unit 145 may generate a display picture in which at least one of objects included in the content is emphasized or blurred. An object refers to a region of a picture or all or part of a subject when the content is a picture. For example, the generation unit 145 may specify objects to be emphasized and/or to be blurred on the basis of the context information determined by the context determination unit 143 and the details of the content acquired by the content acquisition unit 141. Thereafter, the generation unit 145 generates a display picture subjected to conversion for emphasizing the object corresponding to the emphasis target and blurring the object corresponding to the blurring target. Note that the generation unit 145 may generate a display picture which represents an object as it is when the object is neither an emphasis target nor a blurring target and may generate a display picture subjected to conversion to which the influence of conversion performed on other objects has been added. Various conversion processes performed by the generation unit 145 may be conceived.

For example, the generation unit 145 may generate a display picture in which the contrast of an emphasis target object has been emphasized. Also, the generation unit 145 may generate a display picture in which an emphasis target object has been emphasized by being enclosed. Also, the generation unit 145 may generate a display picture in which an emphasis target object has been displayed in a separate frame. Also, the generation unit 145 may generate a display picture in which an emphasis target object has been displayed in color and other objects have been displayed in grayscale or monochrome.

For example, the generation unit 145 may generate a display picture in which the contrast of a blurring target object has been decreased. Also, the generation unit 145 may generate a display picture in which a blurring target object has been displayed in light colors or a display picture in which the object has been displayed in grayscale or monochrome.

For example, the generation unit 145 may generate a display picture in which the disposition of objects has been changed. For example, the generation unit 145 may move a blurring target object to an inconspicuous position such as a position away from the center of a picture and move an emphasis target object to a conspicuous position such as the center of the picture.

For example, the generation unit 145 may generate a display picture by allocating a number of pixels depending on acquired content, metadata of the content and context information to each object. For example, the generation unit 145 may allocate a large number of pixels to an emphasis target object. Accordingly, the visibility of the emphasis target object is improved. However, part of the display picture may be distorted or an originally existing blank part may disappear. Also, the generation unit 145 may allocate a small number of pixels to a blurring target object. In this case, the generation unit 145 can generate a display picture in which the blurring target object has been blurred in such a manner that a grotesque part is shaded off to decrease visibility of such a part.

The generation unit 145 may employ any algorithm for generating a display picture corresponding to content. For example, when the content is a picture, the generation unit 145 may perform local affine transformation. An algorithm which can be employed by the generation unit 145 is described in, for example, “Scott Schaefer, Travis McPhail, Joe Warren, “Image deformation using moving least squares,” ACM Transactions on Graphics (TOG)—Proceedings of ACM SIGGRAPH 2006, Volume 25, Issue 3, July 2006, Pages 533 to 540”.

The generation unit 145 may calculate the number of pixels allocated to each object using various methods. Here, the number of pixels allocated to an emphasis target object is, for example, a value equal to or greater than a minimum number of pixels according to which a user can read the object when the object is characters, and a value equal to or greater than a minimum number of pixels according to which the object can be recognized when the object is another object, in regard to the details of objects. Accordingly, the number of pixels allocated to, for example, a blank part or the like is lower. On the other hand, the number of pixels allocated to a blurring target object is, for example, a value equal to or less than a maximum number of pixels according to which a user cannot read the object when the object is characters, and a value equal to or less than a maximum number of pixels according to which the object cannot be recognized when the object is another object, in regard to the details of objects.

However, the number of pixels allocated to an object may be changed according to the context. For example, in a correction operation necessary to discriminate the letter “O” from a numeral “0”, and the like with respect to an emphasis target object, the number of pixels allocated to a character is higher than usual. Also, the number of pixels allocated to a word important for a user in a document is higher than usual. Further, when a user wants to see a picture of a person frequently when the picture is small but recognizable, the number of pixels allocated to the picture of the person may be higher than usual. Photos of children viewed during going home from work, photos of grandchildren viewed after a long interval, and the like correspond to such a context. In regard to a blurring target object, the number of allocated pixels may be changed according to the context, similarly.

Hereinafter, a process for allocating a number of pixels depending on the details of content will be described.

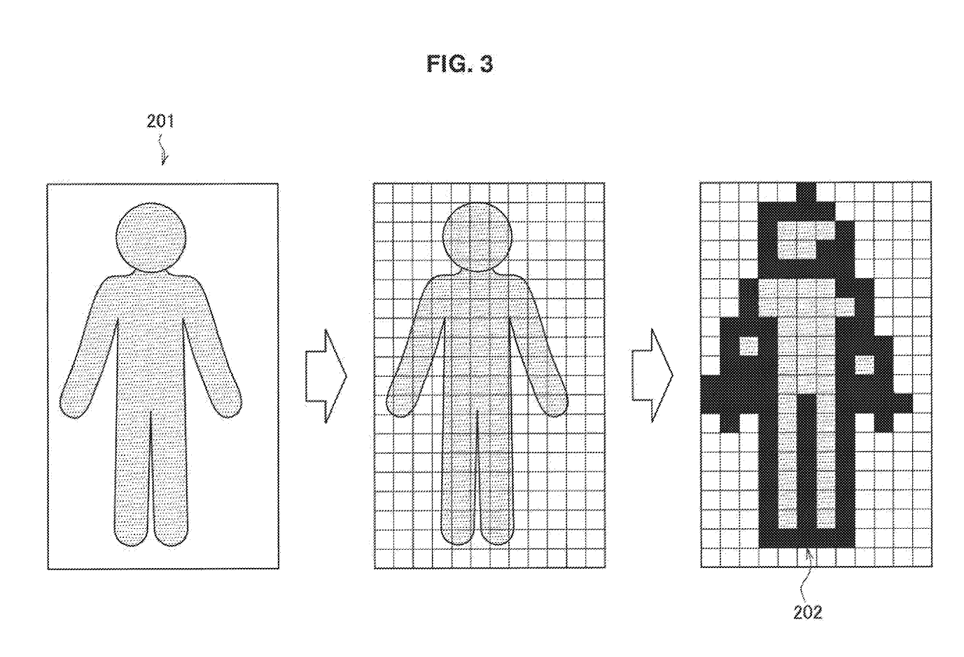

For example, the generation unit 145 calculates the number of pixels allocated to an emphasis target object from the details of content. For example, when the content is a still picture, the generation unit 145 may recognize characters, icons and other significant objects included in the picture and calculate the number of pixels to be allocated on the basis of visibility in an actual display size of a recognized object. As a significant object, for example, a face of a person, a body part other than the face, a specific shape, an animal, a plant, a vehicle or the like may be conceived in addition to characters and icons. Also, when the content is a still picture, the generation unit 145 may calculate the number of pixels to be allocated from a result obtained by a Fourier transform or wavelet transform. In this case, for example, the generation unit 145 may analyze a frequency component of each part of the picture by performing a Fourier transform or wavelet transform and identify a part having a high frequency component amount equal to or greater than a threshold value as an emphasis target object. However, high frequency components are not noticeable due to human perception characteristics, in general, and thus an emphasis target object may be identified after correction depending on human perception frequency characteristics is performed. Then, the generation unit 145 may calculate the number of pixels to be allocated from the amount of frequency components in the emphasis target part. An example of this analysis method will be described in detail with reference to FIG. 3.

FIG. 3 is a diagram for describing an example of a content analysis process according to the present embodiment. As illustrated in FIG. 3, first of all, the generation unit 145 divides a content 201 of a picture of a person into a lattice form. Thereafter, the generation unit 145 performs frequency analysis and correction depending on human perception characteristics on the picture divided into a lattice form to identify an emphasis target part 202. Here, the emphasis target part 202 corresponds to an outline part of the person. For example, the generation unit 145 may generate a display picture in which the outline part of the person has become distinct by allocating a large number of pixels to the outline part of the person.

Note that allocation of a large number of pixels may also be referred to as simply enlargement. Also, allocation of a small number of pixels may be referred to as simply reduction. Although the generation unit 145 enlarges an emphasis target object and reduces the size of a blurring target part in the description, the generation unit 145 may perform a conversion process other than the aforementioned one.

The generation unit 145 may generate a display picture at various timings. For example, the generation unit 145 may generate a display picture at a timing at which display target content changes. In addition, the generation unit 145 may re-generate a display picture at a timing at which a context changes. As a timing at which a context changes, for example, changing of a topic of a conversation, changing of a position in an audio book read to, changing of a person who views a display picture, changing of a user position, changing of a display device and the like may be conceived. In addition, the generation unit 145 may generate a display picture at timing indicated by a user, screen refresh timing and the like.

Also, various types of content may be conceived in addition to still pictures. For example, when content is a plurality of still pictures captured by changing photographing conditions, the generation unit 145 may focus on a part to be emphasized when the plurality of still pictures are combined. Also, when the content is a moving picture, the generation unit 145 may regard the moving picture as consecutive still pictures and similarly perform the above-described process. Also, when the content is a web page or a character string, the generation unit 145 may perform adjustment of a character size, arrangement and the like. Also, when the content is sound, the generation unit 145 may extend a playback time of a section to be emphasized or set the section to be emphasized to a normal speed and increase the speed in other sections.

### (Generation of Display Picture Depending on Details of Content)

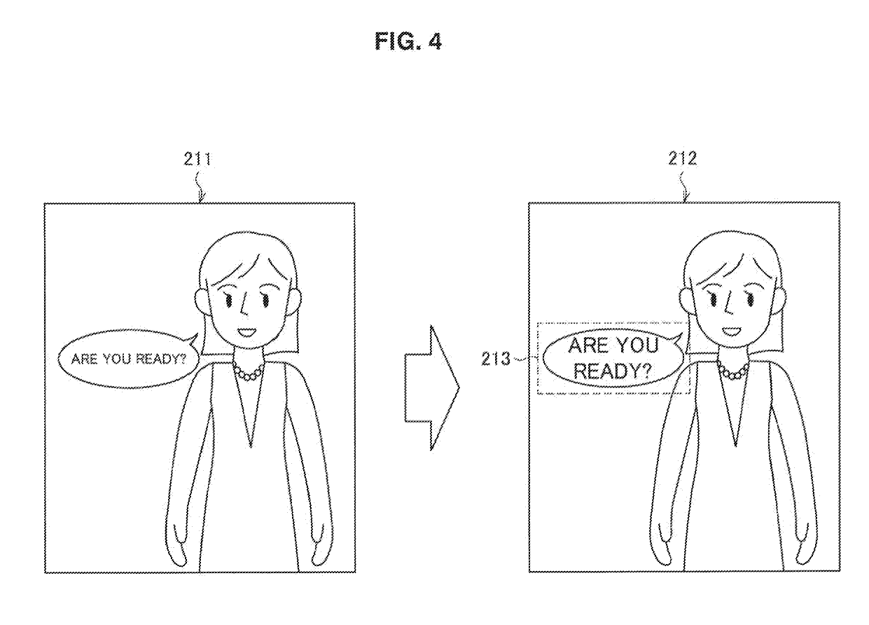

Hereinafter, a specific example of a process of generating a display picture depending on the details of content will be described with reference to FIGS. 4 to 6.

FIG. 4 is a diagram for describing an example of a process of generating a display picture according to the present embodiment. In the example illustrated in FIG. 4, content 211 is a still picture which is a cartoon. For example, the generation unit 145 may generate a display picture 212 in which characters in a balloon part 213 have been enlarged while other parts of the picture have been maintained as they are. Accordingly, readability of the balloon part is secured.

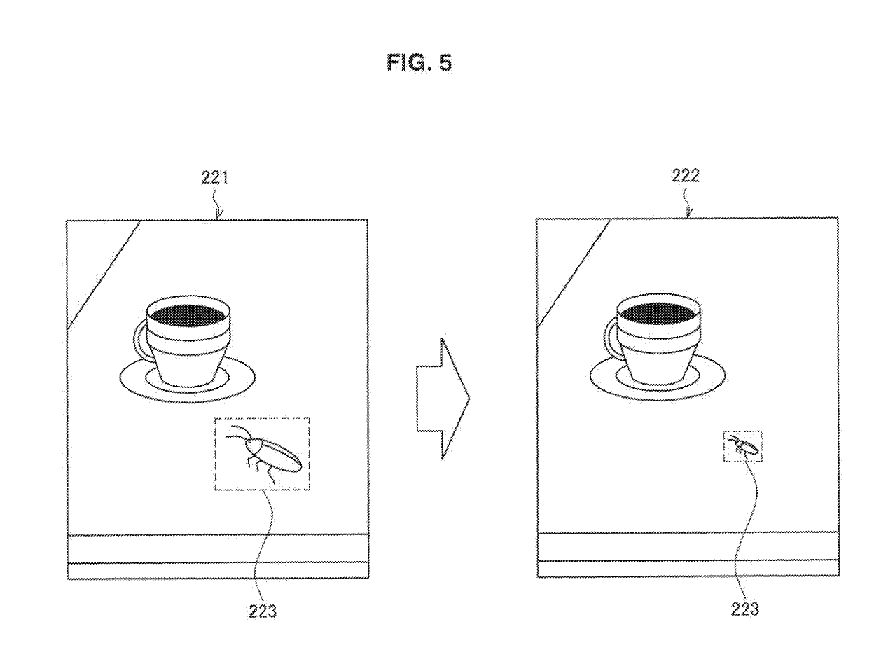

FIG. 5 is a diagram for describing an example of the process of generating a display picture according to the present embodiment. In the example illustrated in FIG. 5, content 221 is a still picture including a photo of a cockroach 223. For example, the generation unit 145 may generate a display picture 222 in which the cockroach 223 has been reduced in size. Accordingly, an undesirable part such as a cockroach is reduced in size and displayed. As an undesirable part, a part having grotesque expression, an excessively flickering part or the like may be conceived in addition to a specific insect such as a cockroach.

As another example, when the content is a short message service (SMS), for example, the generation unit 145 may generate a display picture in which a message part has been enlarged. Also, when the content is an electronic book which is a technical book, the generation unit 145 may generate a display picture in which a character part has been enlarged. Also, when the content is a group photo, the generation unit 145 may generate a display picture in which a face part has been enlarged. Also, when the content is a lyrics card, the generation unit 145 may generate a display picture in which a character part has been enlarged. Also, when the content is a photo of Mt. Fuji, the generation unit 145 may generate a display picture in which Mt. Fuji has been enlarged.

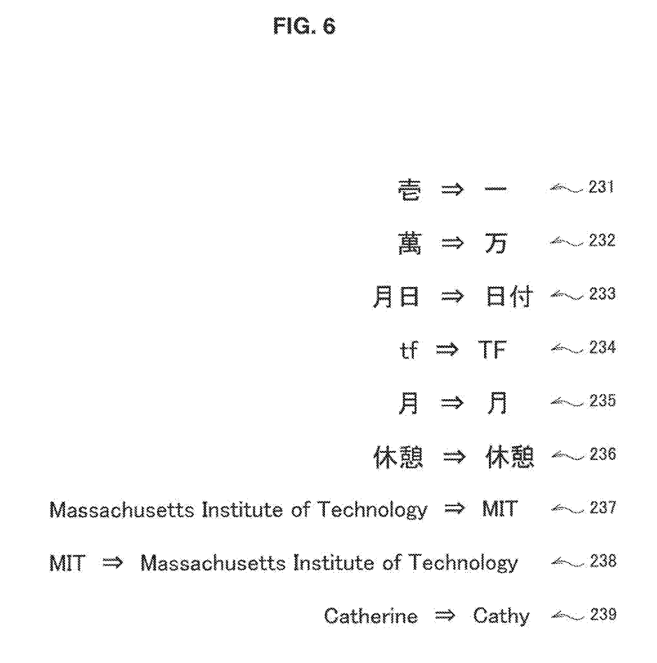

The generation unit 145 may generate a display picture by converting notation included in content into notation with improved visibility. For example, the generation unit 145 performs conversion into different notation such as a different character form, marks and yomigana such that the meaning of text including converted wording does not change between before and after conversion. Hereinafter, an example of a process of generating a display picture by converting notation will be described with reference to FIG. 6.

FIG. 6 is a diagram for describing an example of the process of generating a display picture according to the present embodiment. As illustrated by symbols 231 to 233 in FIG. 6, the generation unit 145 may convert wording with a large number of strokes into wording with a small number of strokes. Also, the generation unit 145 may convert the letters from small letters to capital letters as represented by symbol 234. Here, a character converted to may not be an existing character, and one or more lines may be eliminated from a character, as represented by symbols 235 and 236, for example. Accordingly, the visibility of text of a part having a small number of pixels allocated thereto, for example, can be improved. In addition, the generation unit 145 may convert a long description into an abbreviation as represented by symbol 237 and may convert an abbreviation into an original long description as represented by symbol 238. Also, the generation unit 145 may convert a name into a short nickname as represented by symbol 239. Note that such conversion rules may be stored in the storage unit 130.

A specific example of the process of generating a display picture depending on the details of content has been described.

### (Generation of Display Picture Depending on Context Information)

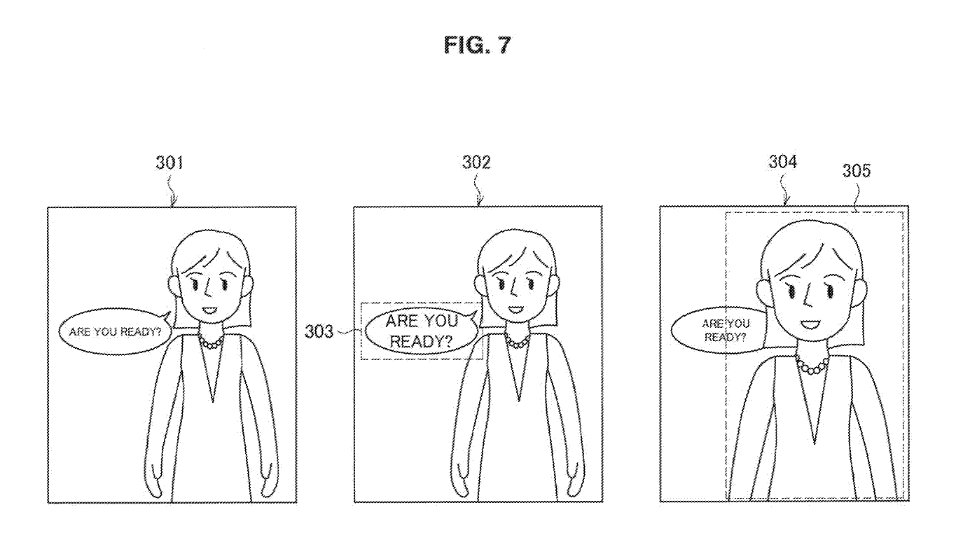

Hereinafter, an example of a process of generating a display picture depending on context information will be described with reference to FIGS. 7 to 24.

FIG. 7 is a diagram for describing an example of the process of generating a display picture according to the present embodiment. The example illustrated in FIG. 7 is an example of a case in which context information is information related to the knowledge or preference of a user regarding the content. In the example illustrated in FIG. 7, a content 301 is a still picture which is a cartoon. For example, the generation unit 145 generates a display picture 302 in which characters in a balloon part 303 have been enlarged when the user reads the content for the first time. On the other hand, when the user reads the content several times, the generation unit 145 generates a display picture 304 in which a picture part 305 other than the balloon part has been enlarged.

Also, the example illustrated in FIG. 7 may be regarded as an example of a case in which context information is information related to the knowledge or preference of a user regarding the content and information related to an environment of the user. For example, when the user is on board a commuter train, the generation unit 145 may generate the display picture 302 in which characters in the balloon part 303 have been enlarged in order to improve the visibility of the characters in a swaying vehicle.

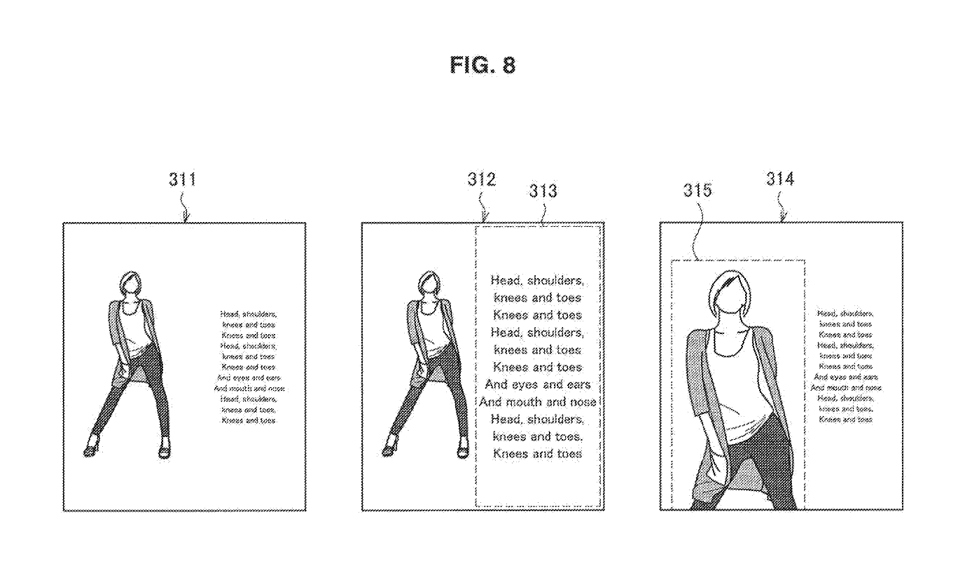

FIG. 8 is a diagram for describing an example of the process of generating a display picture according to the present embodiment. The example illustrated in FIG. 8 is an example of a case in which context information is sound information based on viewing of a display picture and information related to the knowledge or preference of a user regarding the content. In the example illustrated in FIG. 8, content 311 is a still picture which is a lyrics card. For example, the generation unit 145 generates a display picture 312 in which a lyrics part 313 has been enlarged when the user listens to the song of the lyrics card while viewing the lyrics card or views the lyrics card for the first time. On the other hand, when the user views the lyrics card while listening to a song other than the lyrics card or listens to the song of the lyrics card several times, the generation unit 145 generates a display picture 314 in which a photo part 315 has been enlarged.

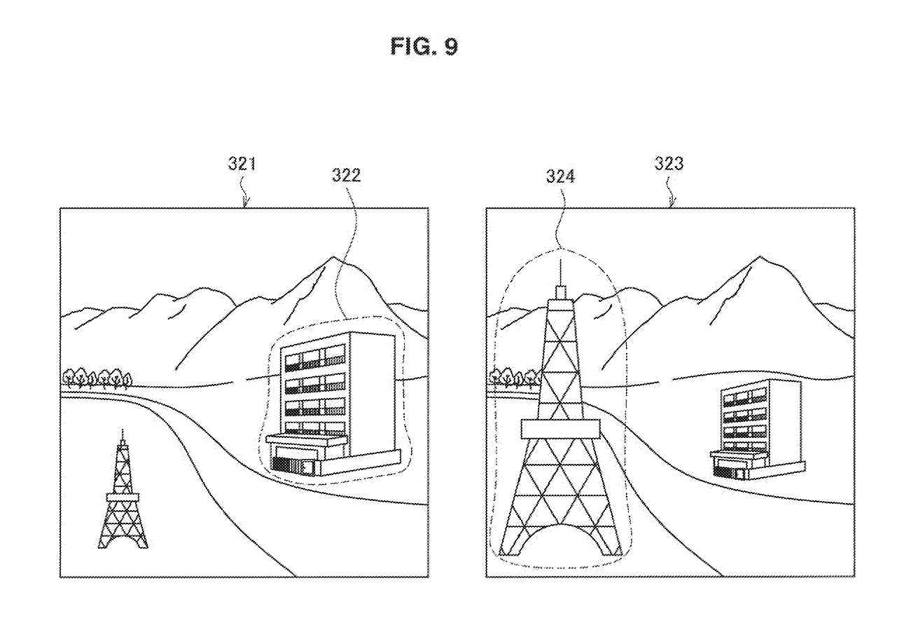

FIG. 9 is a diagram for describing an example of the process of generating a display picture according to the present embodiment. The example illustrated in FIG. 9 is an example of a case in which context information is information related to the purpose of viewing the content of a user and sound information based on viewing of a display picture. In the example illustrated in FIG. 9, the content is a still picture of scenery. For example, when the user talks about a building 322 at the front of a photo, the generation unit 145 may generate a display picture 321 in which the building 322 has been enlarged in order to promote conversation about the building 322. On the other hand, when the user talks about a tower 324 further inwards in the photo, the generation unit 145 generates a display picture 323 in which the tower 324 has been enlarged in order to promote conversation about the tower 324.

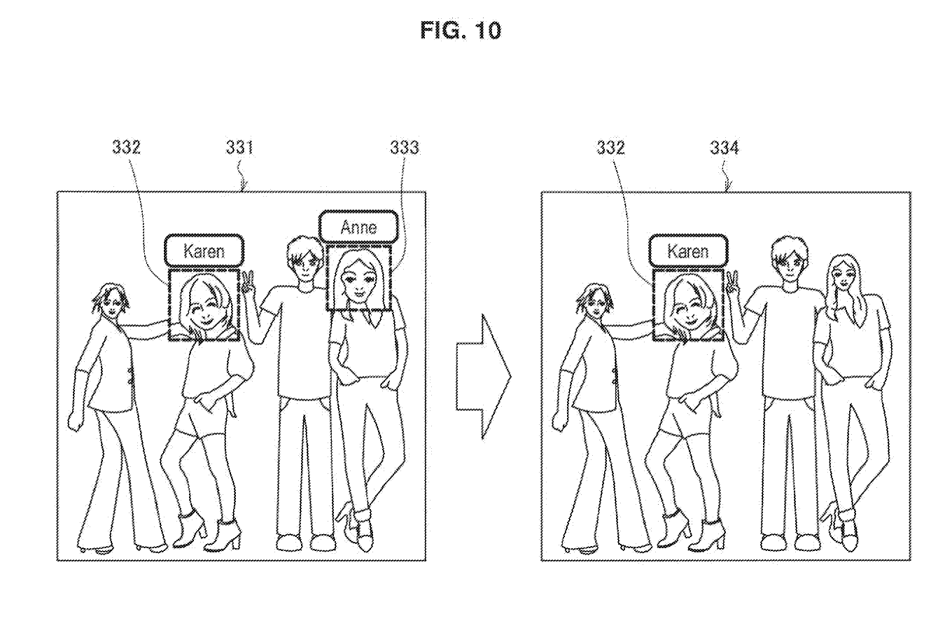

FIG. 10 is a diagram for describing an example of the process of generating a display picture according to the present embodiment. The example illustrated in FIG. 10 is an example of a case in which context information is information related to properties of a user. In the example illustrated in FIG. 10, the content is a still picture which is a group photo of people. For example, the generation unit 145 generates a display picture 331 in which a face part 332 of “Karen” who is a common friend and a face part 333 of “Ann” have been enlarged, enclosed and tagged with the names on the basis of a friend relationship of the user. Also, when a user is newly added, the generation unit 145 generates a display picture 334 in which the face part 332 of “Karen” who is a common friend of the added user and the existing user has been enlarged, enclosed and tagged with the name.

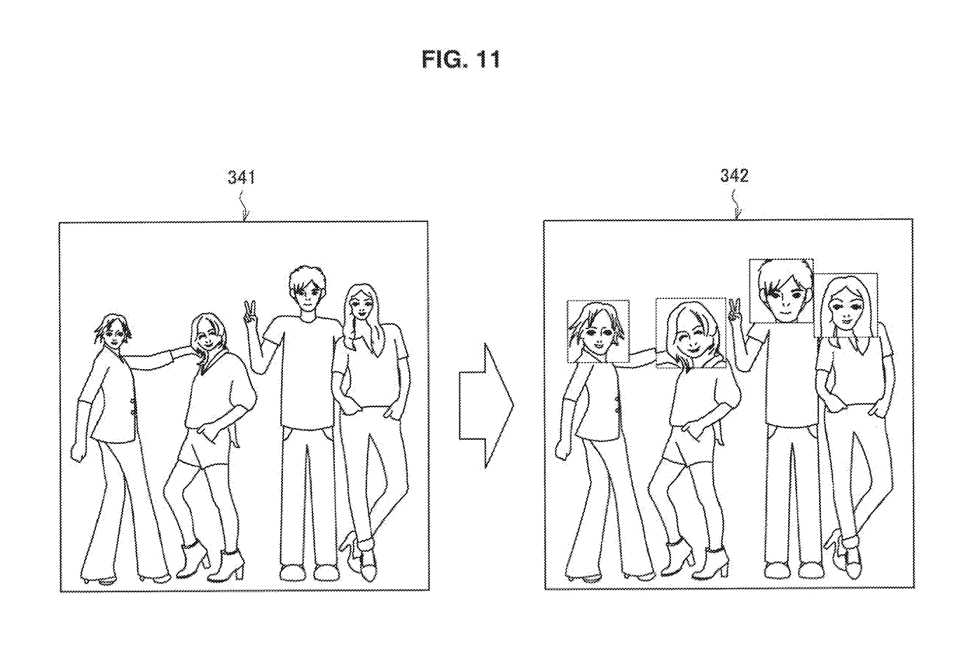

FIG. 11 is a diagram for describing an example of the process of generating a display picture according to the present embodiment. The example illustrated in FIG. 11 is an example of a case in which context information is information related to the purpose of viewing content of a user. In the example illustrated in FIG. 11, the content is a still picture which is a group photo of people. For example, the generation unit 145 generates a display picture 342 in which face parts have been enlarged when the user has the purpose of tagging photographed people.

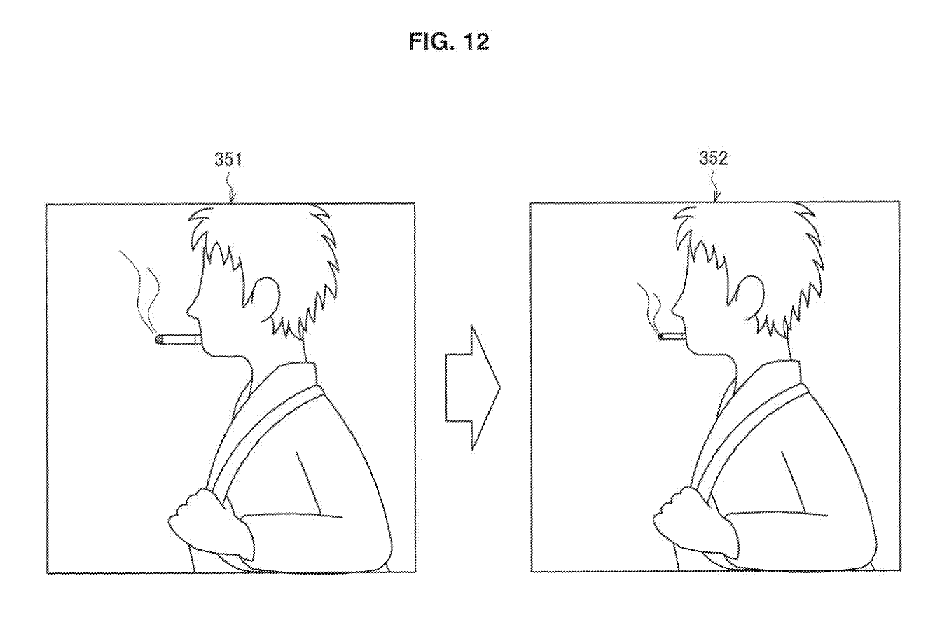

FIG. 12 is a diagram for describing an example of the process of generating a display picture according to the present embodiment. The example illustrated in FIG. 12 is an example of a case in which context information is information related to properties of a user. In the example illustrated in FIG. 12, content 351 is a still picture of a person who is smoking. For example, the generation unit 145 generates a display picture 352 in which a cigarette has been reduced when the user is a child or in the case of a plurality of users including a child. On the other hand, the generation unit 145 generates a display picture in which the cigarette is represented in an unchanged size when a child is not included in users. In addition, the generation unit 145 may perform similar processing for content inappropriate for children such as grotesque expression, static expression and alcohol. Also, the generation unit 145 may not only reduce an inappropriate part but also eliminate an inappropriate part.

A case in which the user holds a conversation about the cigarette in the example illustrated in FIG. 12 may be considered. In such a case, a conflict may occur in a conversion policy depending on context information regarding whether to enlarge the cigarette part coming up in conversation or whether to reduce the cigarette part in consideration of a child. Accordingly, the setting unit 147 which will be described below previously sets a priority to context information on the assumption of such a case. Accordingly, the generation unit 145 may generate a display picture in which the cigarette part has been reduced in consideration of a child, for example.

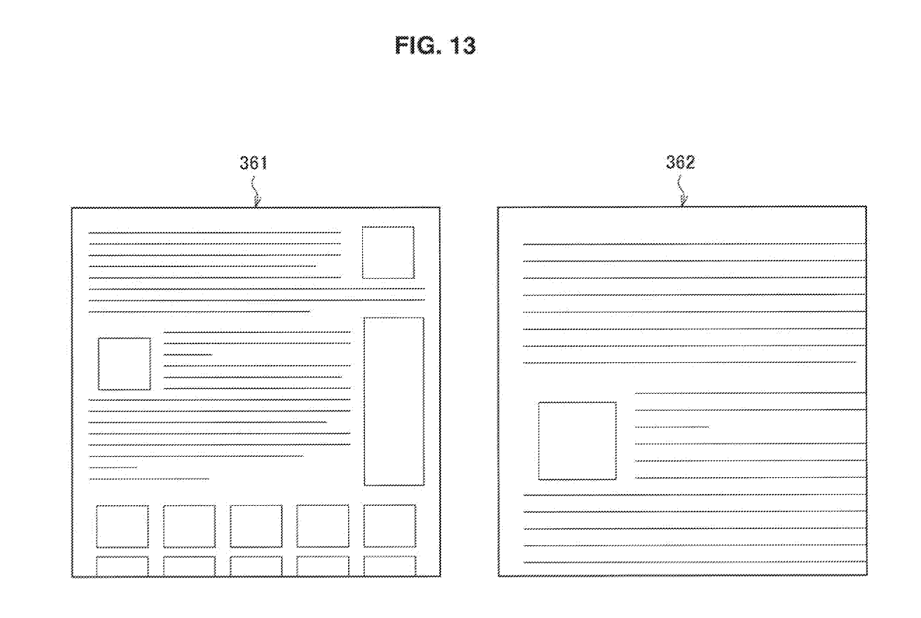

FIG. 13 is a diagram for describing an example of the process of generating a display picture according to the present embodiment. The example illustrated in FIG. 13 is an example of a case in which context information is information related to a positional relationship between the display unit 120 which displays a display picture and a user. In the example illustrated in FIG. 13, the content is a web page. For example, the generation unit 145 generates a display picture 361 in which the entire web page has been reduced when the distance between the display unit 120 and the user is short. On the other hand, when the distance between the display unit 120 and the user is long, the generation unit 145 generates a display picture 362 in which the entire web page has been enlarged and a part which is not included in the screen has been omitted. Accordingly, the user can secure high visibility independently of the distance to the screen.

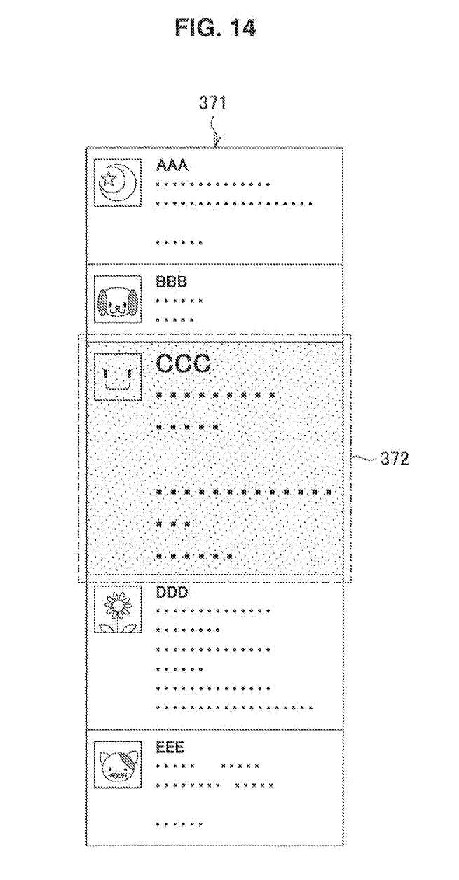

FIG. 14 is a diagram for describing an example of the process of generating a display picture according to the present embodiment. The example illustrated in FIG. 14 is an example of a case in which context information is information related to properties of a user. In the example illustrated in FIG. 14, the content is a timeline of TWITTER (registered trademark). For example, the generation unit 145 generates a display picture 371 in which a TWEET (registered trademark) 372 of the user and a person who is viewing the screen with the user has been enlarged on the basis of a friend relationship of the user or a relationship between a followee and followers on TWITTER.

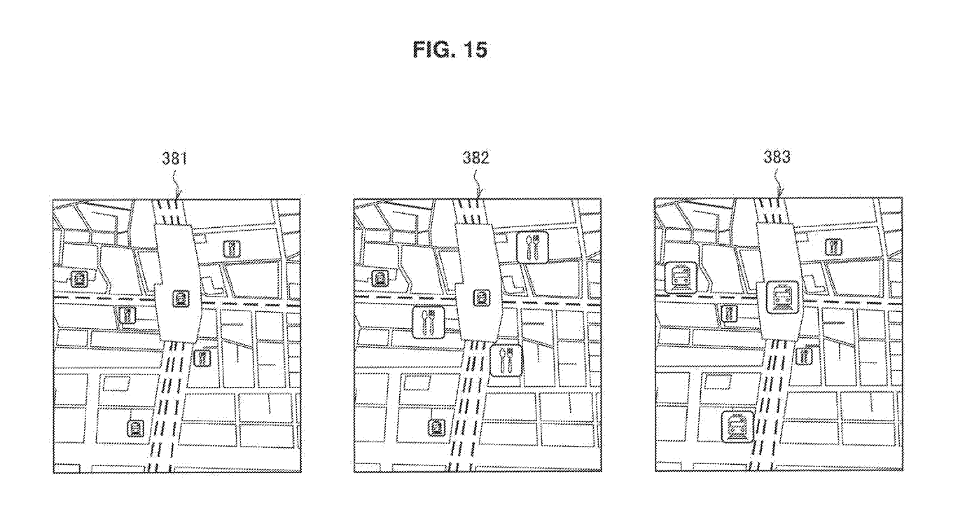

FIG. 15 is a diagram for describing an example of the process of generating a display picture according to the present embodiment. The example illustrated in FIG. 15 is an example of a case in which context information is information related to the purpose of viewing content of a user. In the example illustrated in FIG. 15, the content is a map 381. For example, the generation unit 145 generates a display picture 382 in which icons indicating restaurants have been enlarged when the user searches for a restaurant. On the other hand, the generation unit 145 generates a display picture 383 in which icons indicating stations have been enlarged when the user searches for a station.

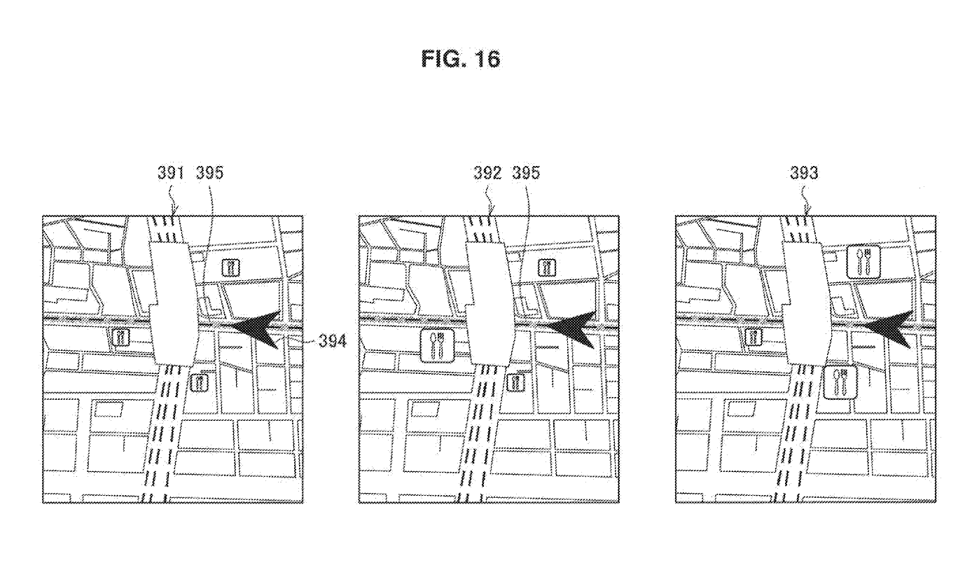

FIG. 16 is a diagram for describing an example of the process of generating a display picture according to the present embodiment. The example illustrated in FIG. 16 is an example of a case in which context information is information related to the purpose of viewing content of a user, information related to an environment of the user and action information based on viewing of a display picture. In the example illustrated in FIG. 16, the content is a map 391 including an icon 394 indicating a current position and a moving direction of a user. For example, when the user searches for a restaurant at the position indicated by the icon 394 during movement using a vehicle, the generation unit 145 generates a display picture 392 in which an icon indicating a restaurant having a parking lot along a road 395 on which the vehicle is running has been enlarged. On the other hand, when the user searches for a restaurant at the position indicated by the icon 394 while moving on foot, the generation unit 145 generates a display picture 393 in which an icon indicating a restaurant close to the current position has been enlarged.

Also, the example illustrated in FIG. 16 may be regarded as an example of a case in which the context information is information related to properties of a user and information related to an environment of the user. For example, when a break time of the user is limited, the generation unit 145 generates the display picture 393 in which an icon indicating a restaurant close to the current position has been enlarged such that the user can finish lunch within a break time.

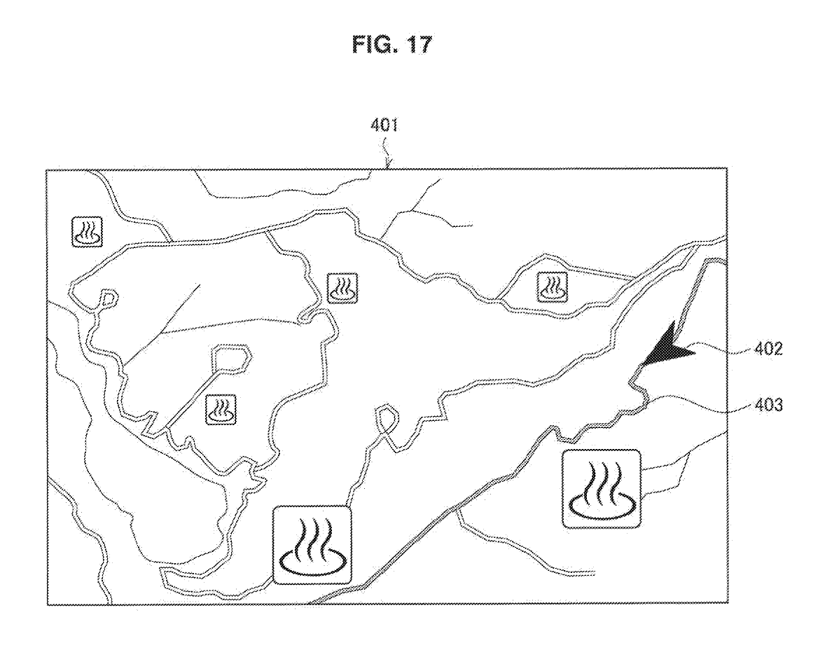

FIG. 17 is a diagram for describing an example of the process of generating a display picture according to the present embodiment. The example illustrated in FIG. 17 is an example of a case in which context information is information related to the purpose of viewing content of a user, information related to an environment of the user and action information based on a display picture. In the example illustrated in FIG. 17, the content is a map including an icon 402 indicating a current position and a moving direction of a user. For example, when the user searches for a hot spring facility at the position indicated by the icon 402 during movement using a vehicle, the generation unit 145 generates a display picture 401 in which icons indicating hot spring facilities along a road 403 on which the vehicle is running has been enlarged.

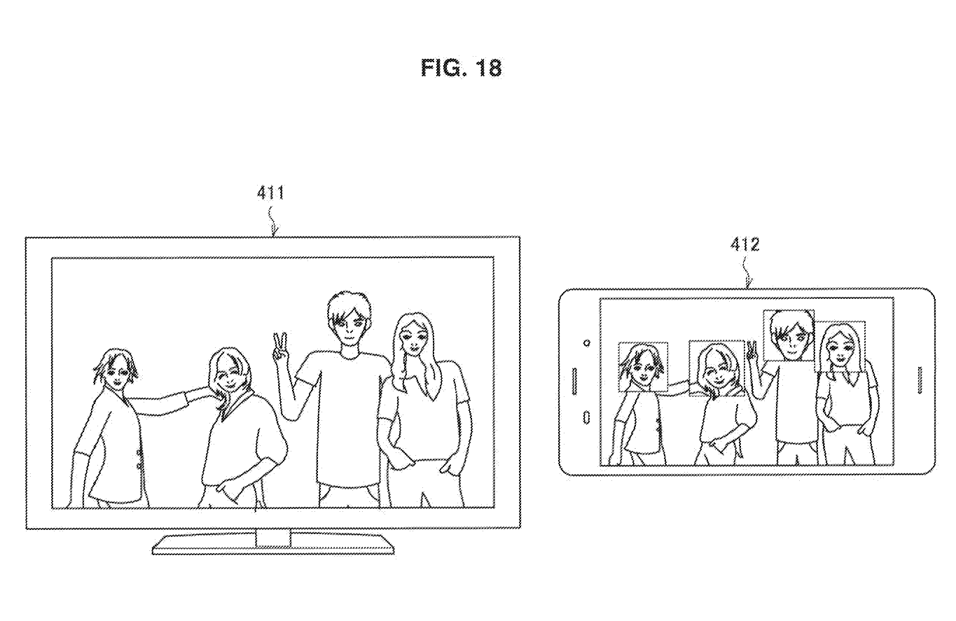

FIG. 18 is a diagram for describing an example of the process of generating a display picture according to the present embodiment. The example illustrated in FIG. 18 is an example of a case in which context information is information related to the purpose of viewing content of a user and information indicating characteristics related to the display unit 120 which displays a display picture. In the example illustrated in FIG. 18, the content is a still picture which is a group photo of people and the user has a purpose of tagging faces of photographed people. For example, when the display unit 120 which displays a display picture is a large display such as a TV receiver or a PC, the generation unit 145 displays a display picture 411 expressing the content as it is since sufficient visibility is secured. On the other hand, when the display unit 120 which displays a display picture is a small display such as a smartphone or a tablet, the generation unit 145 generates a display picture 412 in which face parts have been enlarged in order to secure sufficient visibility.

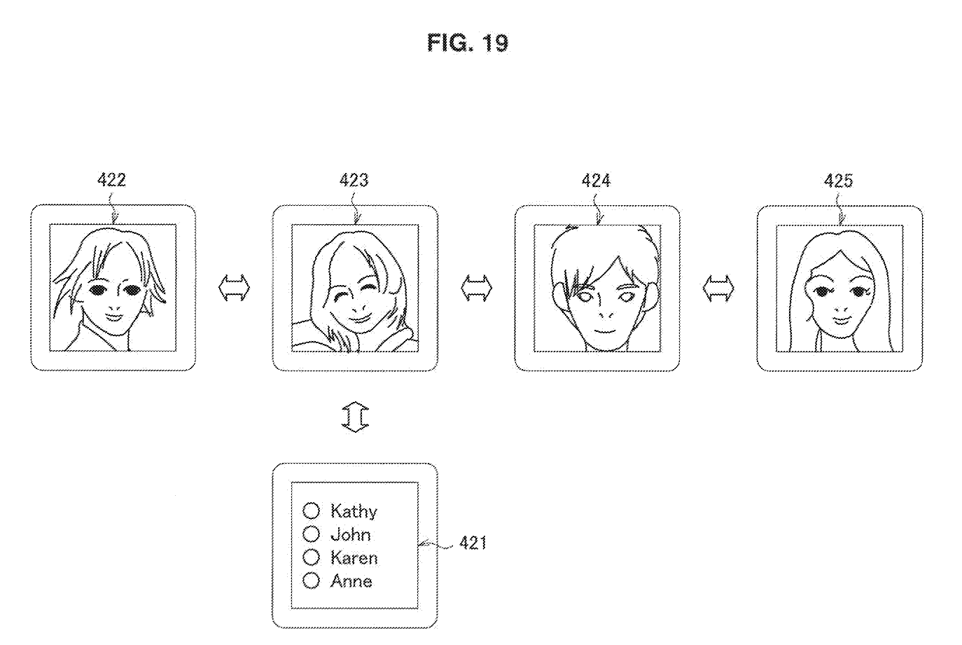

FIG. 19 is a diagram for describing an example of the process of generating a display picture according to the present embodiment. The example illustrated in FIG. 19 is an example of a case in which context information is information related to the purpose of viewing content of a user and information indicating characteristics related to the display unit 120 which displays a display picture. In the example illustrated in FIG. 18, the content is a still picture which is a group photo of people and the user has a purpose of tagging faces of photographed people. For example, when the display unit 120 which displays a display picture is a small display such as a wrist type device, the generation unit 145 generates a display picture 421 for selecting a tag to be attached to a picture and display pictures 422 to 425 displaying face parts in order to secure sufficient visibility. For example, the user may perform tagging according to voice input by switching the display pictures 422 to 425 through a flick manipulation in the horizontal direction or select a tag for tagging in the display picture 421 switched to through a flick manipulation in the vertical direction.

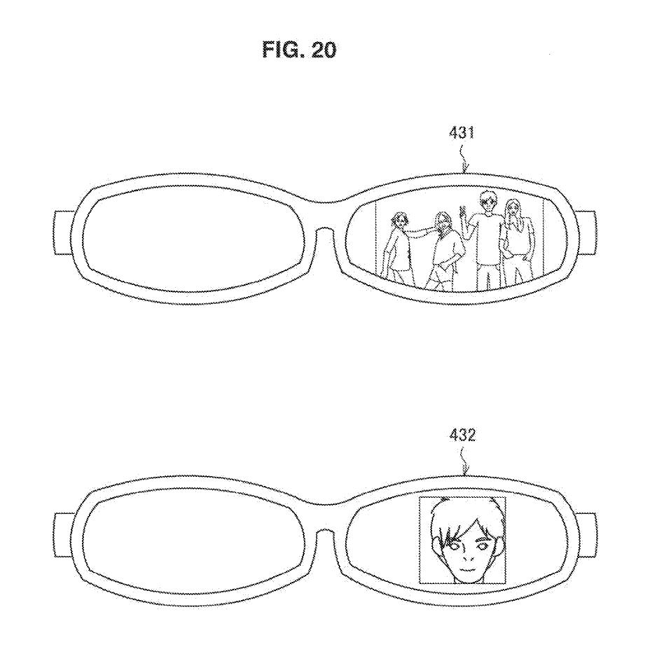

FIG. 20 is a diagram for describing an example of the process of generating a display picture according to the present embodiment. The example illustrated in FIG. 20 is an example of a case in which context information is information related to the purpose of viewing content of a user and information indicating characteristics related to the display unit 120 which displays a display picture. In the example illustrated in FIG. 20, the content is a still image of a group photo of people and the user has a purpose of tagging faces of photographed people. For example, when the display unit 120 which displays a display picture is a small display such as a glasses type device but has a large displayable area and high resolution, sufficient visibility is secured, and thus the generation unit 145 generates a display picture 431 expressing the entire content as it is. The display picture generated in this case is the same as that described above with reference to FIG. 18. On the other hand, when the display unit 120 which displays a display picture is a small display such as a glasses type device and has a small displayable area and low resolution, the generation unit 145 generates a display picture 432 displaying a face part in order to secure sufficient visibility. The display picture generated in this case is the same as that described above with reference to FIG. 19.

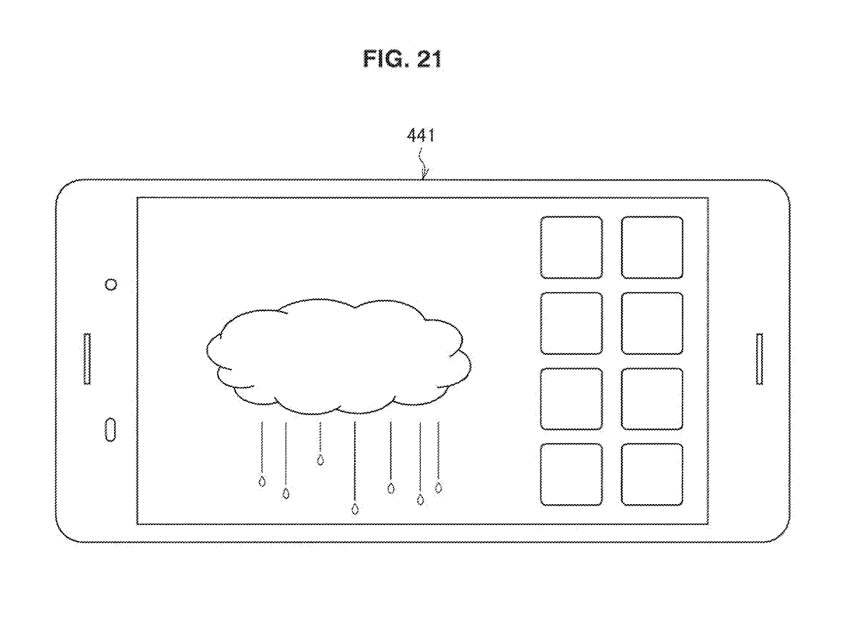

FIG. 21 is a diagram for describing an example of the process of generating a display picture according to the present embodiment. The example illustrated in FIG. 21 is an example of a case in which context information is action information based on viewing of a display picture and information related to an environment of a user. In the example illustrated in FIG. 21, the content is a weather forecast application. For example, when the user has not yet gone to work and it rains, the generation unit 145 generates a display picture 441 for a smartphone in which a weather forecast application display region has been enlarged.

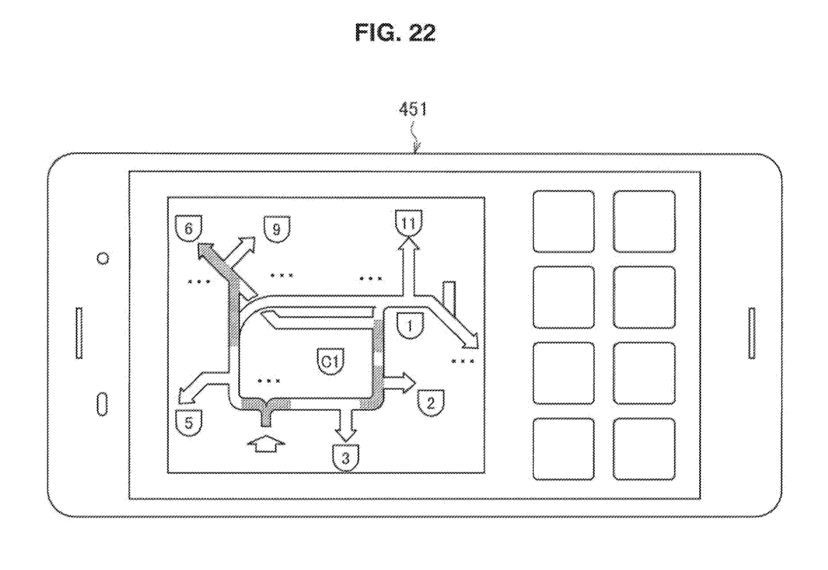

FIG. 22 is a diagram for describing an example of the process of generating a display picture according to the present embodiment. The example illustrated in FIG. 22 is an example of a case in which context information is action information based on viewing of a display picture and information related to an environment of a user. In the example illustrated in FIG. 22, the content is a traffic congestion information application. For example, when the user is traveling by car, the generation unit 145 generates a display picture 451 for a smartphone in which a traffic congestion information application display region from a current position to a destination has been enlarged.

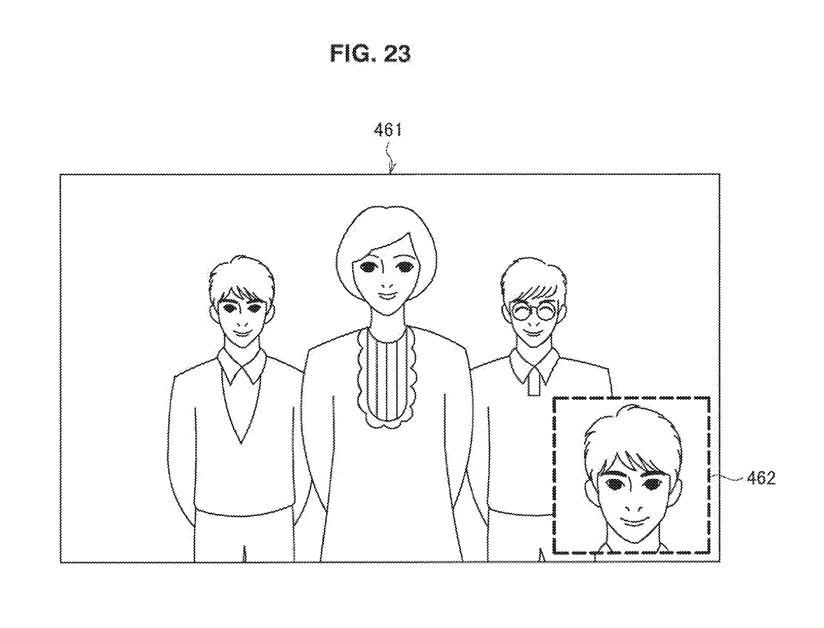

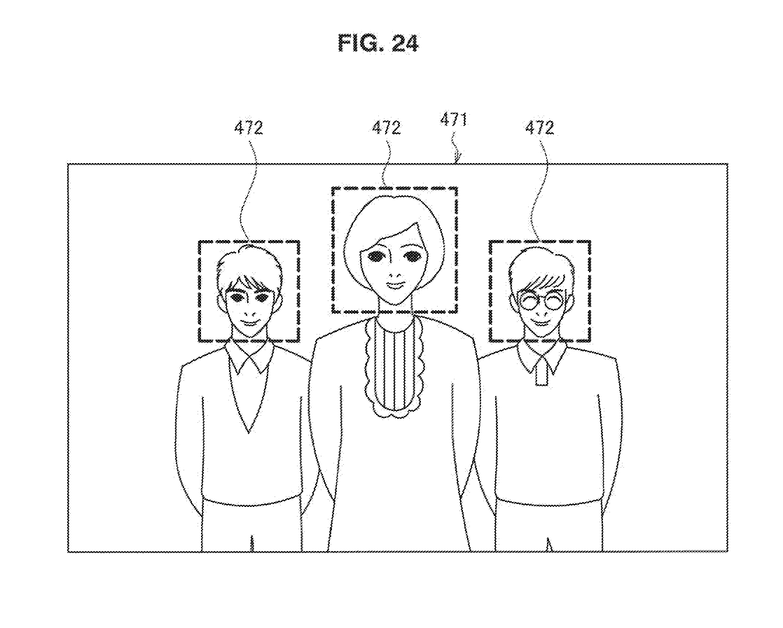

FIG. 23 is a diagram for describing an example of the process of generating a display picture according to the present embodiment. The example illustrated in FIG. 23 is an example of a case in which context information is information related to a region of interest of a user in a display picture. In the example illustrated in FIG. 23, the content is a live moving picture of a music group. For example, the generation unit 145 generates a display picture (moving picture) 461 displaying a face part of an artist, which is previously registered as a region of interest of the user or designated during playback of the moving picture, as a separate frame 462. Note that the generation unit 145 may generate a display picture for selecting the part displayed in the separate frame, as illustrated in FIG. 24. FIG. 24 is a diagram for describing an example of the process of generating a display picture according to the present embodiment. For example, the generation unit 145 may generate a display picture 471 in which face parts of people in the moving picture are candidates 472 for selection. The user can select a candidate 472 for selection through a tap manipulation or the like to cause the face of the selected person to be displayed in the separate frame 462. Although a candidate for selection is the face of a person in the example illustrated in FIG. 24, the candidate may be an object having an identifiable range, such as a human body part other than the face, a specific shape, an animal, a plant or an artificial structure.

Specific examples of the process of generating a display picture depending on context information have been described above.

### (4.4) Setting Unit 147

The setting unit 147 has a function of setting a priority to each piece of context information. For example, when conflicting conversion may be performed on two or more pieces of context information, the setting unit 147 may define which one will be prioritized. The setting unit 147 may set different priorities depending on an application, a service, and the like which display a display picture. Note that when priorities are the same level, there may be a case in which conversion effects cancel each other out. By setting a priority to each piece of context information, conversion depending on appropriate context information according to a situation in which the user views a display picture may be performed. Similarly, the setting unit 147 may set a priority to each piece of context information for a process of generating a display picture depending on the details of content.

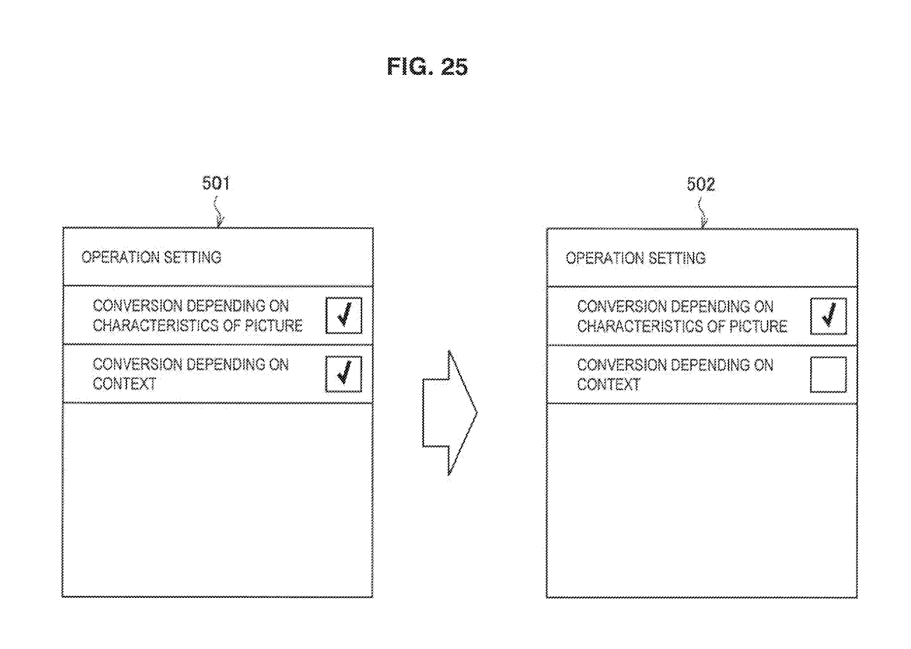

The generation unit 145 may generate a display picture by combining the aforementioned process of generating a display picture depending on the details of content and the process of generating a display picture depending on context information. In regard to this, the setting unit 147 may perform setting such that at least one of the process of generating a display picture depending on the details of content and the process of generating a display picture depending on context information is selectively performed. Here, an example of a setting screen is illustrated in FIG. 25.

FIG. 25 is a diagram for describing an example of a setting screen with respect to the process of generating a display picture according to the present embodiment. FIG. 25 illustrates an example of a setting screen through which ON/OFF of each process can be set by regarding the process of generating a display picture depending on the details of content as “conversion depending on picture characteristics” and regarding the process of generating a display picture depending on context information are “conversion depending context.” On a setting screen 501, both of “conversion depending on picture characteristics” and “conversion depending on context” are checked, and a display picture generation process obtained by combining both the processes is performed. On the other hand, on a setting screen 502, only “conversion depending on picture characteristics” is checked, and thus only the process of generating a display picture depending on the details of content is performed.

### (4.5) Display Control Unit 149

The display control unit 149 has a function of controlling display of content depending on acquired content, metadata of the content and context information. Specifically, the display control unit 149 controls the display unit 120 such that a display picture generated by the generation unit 145 is displayed. For example, the display control unit 149 outputs the display picture to the display unit 120 to display the display picture. The display control unit 149 may control display settings such as a luminance, a display size, a display range and the like.

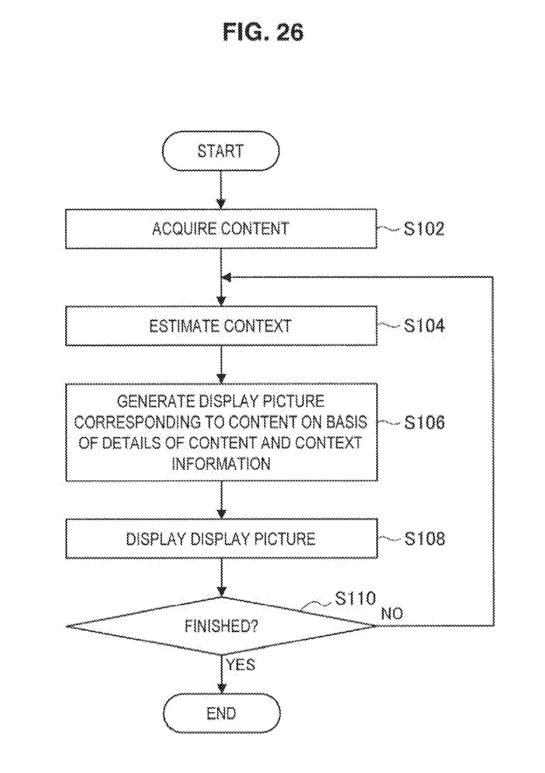

A configuration example of the information processing apparatus 100 according to the present embodiment has been described above. Next, an operation processing example of the information processing apparatus 100 according to the present embodiment will be described with reference to FIG. 26.

### 3. Operation Processing Example

FIG. 26 is a flowchart illustrating an example of a flow of a display picture output process executed in the information processing apparatus 100 according to the present embodiment.

As illustrated in FIG. 26, first of all, the content acquisition unit 141 acquires content in step 5102. For example, the content acquisition unit 141 acquires content input through the input unit 110.

Subsequently, the context determination unit 143 determines a context in step S104. For example, the context determination unit 143 determines a context on the basis of input information input through the input unit 110 and outputs context information.

Thereafter, the generation unit 145 generates a display picture corresponding to the content on the basis of the details of the content and the context information in step S106. For example, the generation unit 145 generates a display picture in which the content has been converted on the basis of the details of the content and the context information as described above with reference to FIGS. 4 to 6 and 7 to 24.

Then, the display unit 120 displays the display picture in step S108. For example, the display control unit 149 outputs the display picture generated by the generation unit 145 to the display unit 120 and controls the display unit 120 such that the display picture is displayed.

An operation processing example according to the present embodiment has been described.

### 4. Modified Example

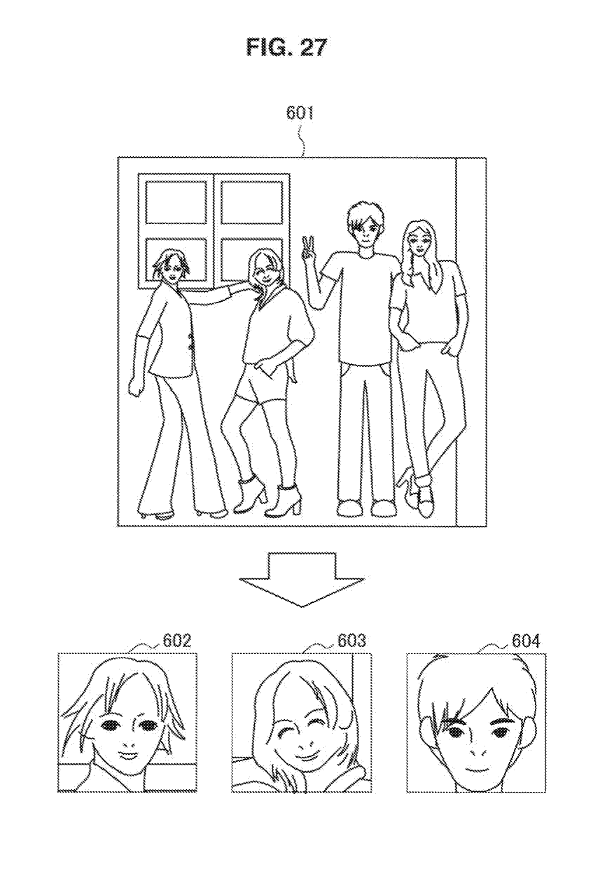

Hereinafter, a modified example according to the present embodiment will be described. The present modification example provides a manipulation environment which is appropriate for a user. Technical features according to the present modification example will be described below in detail with reference to FIGS. 27 to 43.

### 4.1. Technical Features

The generation unit 145 generates a display picture according to a user manipulation input to the input unit 110. For example, the generation unit 145 generates a display picture by enlarging/reducing or scrolling a display picture displayed so far to change the screen, or generates another display picture to change the screen on the basis of a user manipulation applied to the displayed display picture. At this time, the generation unit 145 sets a manipulation method which represents a manipulation and a display process which is executed when the manipulation is performed, and performs the display process according to the set manipulation method.

For example, the generation unit 145 may set a manipulation method applied to a displayed display picture depending on metadata of the content. In other words, the generation unit 145 analyzes a user manipulation input to the input unit 110 according to the manipulation method set depending on the metadata of the content and generates a display picture depending on the analysis result. For example, there is a case in which a display picture is enlarged/reduced or changed to another display picture through the same touch manipulation depending on details of content. According to switching of setting of such a manipulation method, a user can perform a manipulation through a manipulation method adapted to metadata. For example, the user can enlarge a face part of a portrait or enlarge the whole body of one person through the same touch manipulation, or can enlarge or change a cartoon frame by frame. Accordingly, it is not necessary for the user to perform a manipulation such as adjusting an enlargement/reduction ratio or adjusting an enlargement/reduction range, and thus manipulation complexity can be reduced.

For example, the generation unit 145 may set a manipulation method for a displayed display picture depending on context information. In other words, the generation unit 145 analyzes a user manipulation input to the input unit 110 according to a manipulation method set depending on context information and generates a display picture depending on the analysis result. For example, there is a case in which a display picture is enlarged/reduced or changed to another display picture through the same touch manipulation depending on context. According to switching of settings of such a manipulation method, a user can perform a manipulation using a manipulation method adapted to a context. For example, the user can change a display picture when a screen size is large or enlarge a touched part when the screen size is small, through the same touch manipulation. Also, a manipulation of enlarging a display picture may be changed, for example, from a touch manipulation to a gesture manipulation according to a device type, for example. Accordingly, the user can enjoy content freely and without performing complicated setting even with a device for which available manipulations are limited, such as a wearable device or a glasses type device.

Hereinafter, specific examples of manipulation methods will be described.

### 4.2. Specific Examples

Hereinafter, specific examples of manipulation methods which can be selected will be described. The generation unit 145 may set one of manipulation methods which will be described below depending on at least one piece of metadata of content and context information.

### (1) Enlargement and Changing Depending on Metadata

Hereinafter, manipulation methods for enlarging and displaying part of content and sequentially changing the same will be described with reference to FIGS. 27 to 36.

### (1.1) Example of Group Photo

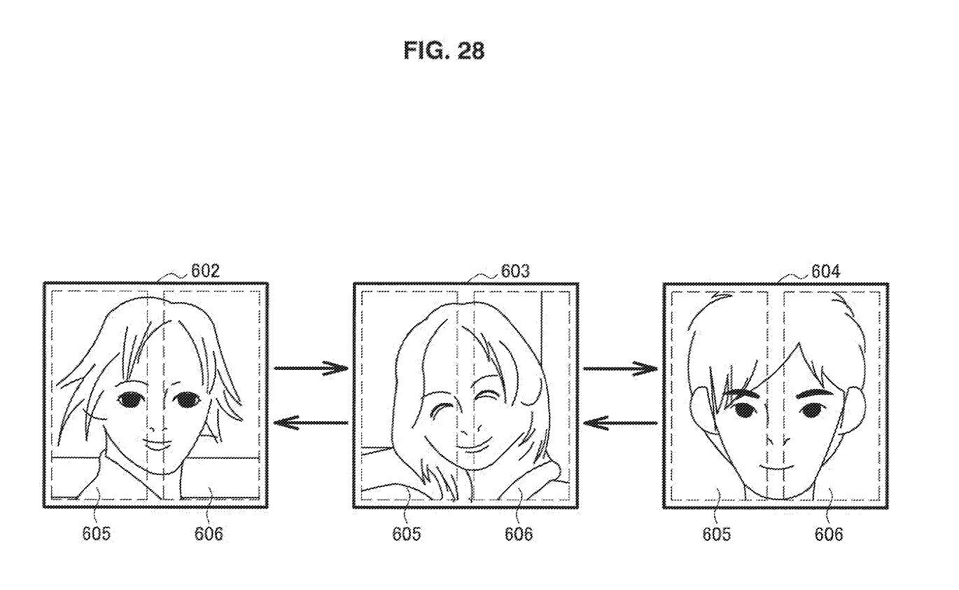

First of all, an example of a manipulation method in a case in which the content is a group photo will be described with reference to FIGS. 27 and 28.

FIG. 27 is a diagram for describing an example of a manipulation method according to the present modified example. In the example illustrated in FIG. 27, a content 601 is a still picture which is a group photo of people. The generation unit 145 may generate a display picture for displaying the content 601 as it is. Also, the generation unit 145 may generate one of display pictures 602, 603 and 604 in which face parts have been enlarged according to the fact that the content 601 is a still picture including people.

FIG. 28 is a diagram for describing an example of a manipulation method according to the present embodiment. In the example illustrated in FIG. 28, screen changing between the display pictures 602, 603 and 604 obtained by enlarging the face pictures illustrated in FIG. 27 is illustrated. When a tap manipulation is performed in a state in which one of the display pictures is displayed, according to the fact that the display picture is obtained by enlarging a face part of a person included in the group photo, the generation unit 145 may generate a display picture in which a face part of another person has been enlarged to change the screen. In such a case, the generation unit 145 may select a person to be changed (i.e., the next person to be enlarged and displayed) from people around the enlarged person in the group photo depending on a tapped position. For example, when a left region 605 of the display picture 603 is tapped, the generation unit 145 generates the display picture 602 of a person who was on the left of the person of the display picture 603 in the original group photo 601 to change the screen. Also, the generation unit 145 generates the display picture 604 of a person who was on the right of the person of the display picture 603 in the original group photo 601 to change the screen when a right region 606 of the display picture 603 is tapped. This is the same for left regions 605 and right regions 606 of the display pictures 602 and 604.

### (1.2) Example of Cartoon

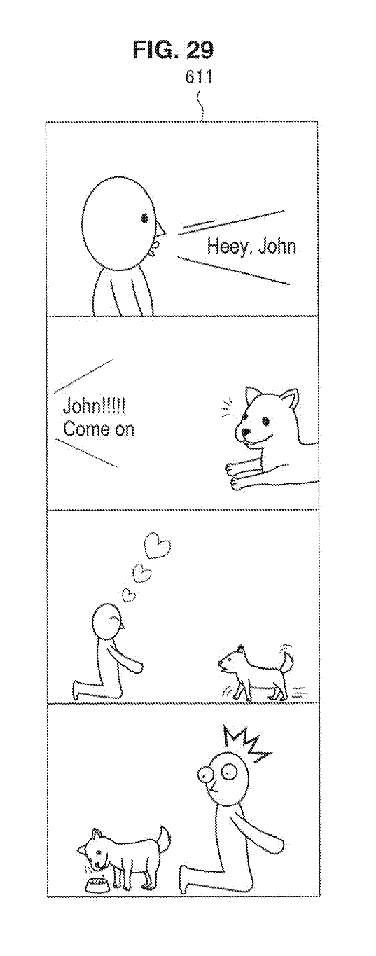

Hereinafter, an example of a manipulation method in a case in which the content is a cartoon will be described with reference to FIGS. 29 to 34.

FIG. 29 is a diagram for describing an example of a manipulation method according to the present modified example. As illustrated in FIG. 29, content 611 is a 4-frame cartoon. The generation unit 145 may generate a display picture for displaying the content 611 as it is. Also, the generation unit 145 may generate a display picture in which one of the frames has been enlarged or a display picture in which part of one frame has been further enlarged according to the fact that the content 611 is a cartoon.

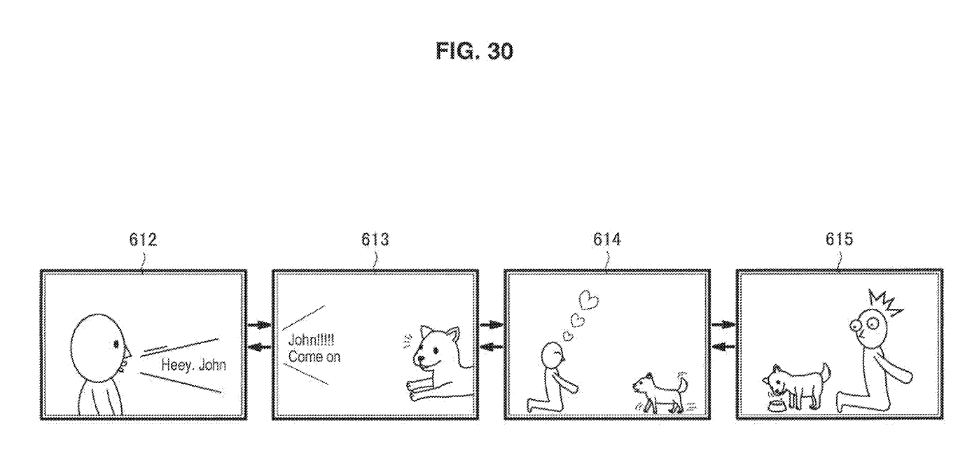

FIG. 30 is a diagram for describing an example of a manipulation method according to the present modified example. FIG. 30 illustrates screen changing between display pictures 612, 613, 614 and 615 obtained by enlarging the respective frames illustrated in FIG. 29. When a tap manipulation is performed in a state in which one of the display pictures is displayed, according to the fact that the display picture is obtained by enlarging one frame of the cartoon, the generation unit 145 may generate a display picture in which another frame has been enlarged to change the screen. In such a case, the generation unit 145 may select a frame to be changed (i.e., the next frame to be enlarged and displayed) from frames before and after the frame enlarged in the cartoon depending on a tapped position. For example, when a left region of the display picture 163 in which the second frame has been enlarged is tapped, the generation unit 145 generates the display picture 612 in which the first frame has been enlarged to change the screen. Also, the generation unit 145 generates the display picture 614 in which the third frame has been enlarged to change the screen when a right region of the display picture 163 in which the second frame has been enlarged is tapped. This is the same for left regions and right regions of the display pictures 612, 614 and 615. Note that when a left region of the display picture 612 in which the first frame has been enlarged is tapped, the generation unit 145 may change the screen to the last frame of the previous page. Also, the generation unit 145 may change the screen to the first frame of the next page when a right region of the display picture 616 of the fourth frame is tapped.

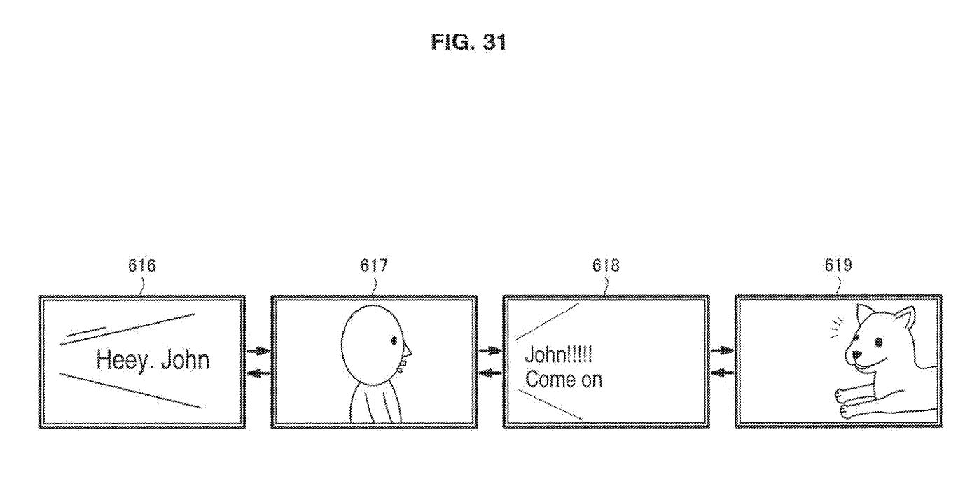

FIG. 31 is a diagram for describing an example of a manipulation method according to the present modified example. FIG. 31 illustrates screen changing between display pictures 616, 617, 618 and 619 obtained by enlarging part of one frame of the cartoon illustrated in FIG. 29. The display picture 616 is obtained by enlarging a character part of the first frame, the display picture 617 is obtained by enlarging a picture part of the first frame, the display picture 618 is obtained by enlarging a character part of the second frame, and the display picture 619 is obtained by enlarging a picture part of the second frame. When a tap manipulation is performed in a state in which one of the display pictures is displayed, according to the fact that the display picture is obtained by enlarging part of one frame of the cartoon, the generation unit 145 may generate a display picture in which another part has been enlarged to change the screen. In such a case, the generation unit 145 may select a part to be changed (i.e., a part of the next frame to be enlarged and displayed) from parts or frames before and after the part enlarged in the cartoon depending on a tapped position. For example, when a left region of the display picture 167 in which the picture part of the first frame has been enlarged is tapped, the generation unit 145 generates the display picture 618 in which the character part of the first frame has been enlarged to change the screen. Also, the generation unit 145 generates the display picture 618 in which the character part of the second frame has been enlarged to change the screen when a right region of the display picture 167 in which the picture part of the first frame has been enlarged is tapped. This is the same for left regions and right regions of the display pictures 616, 618 and 619.

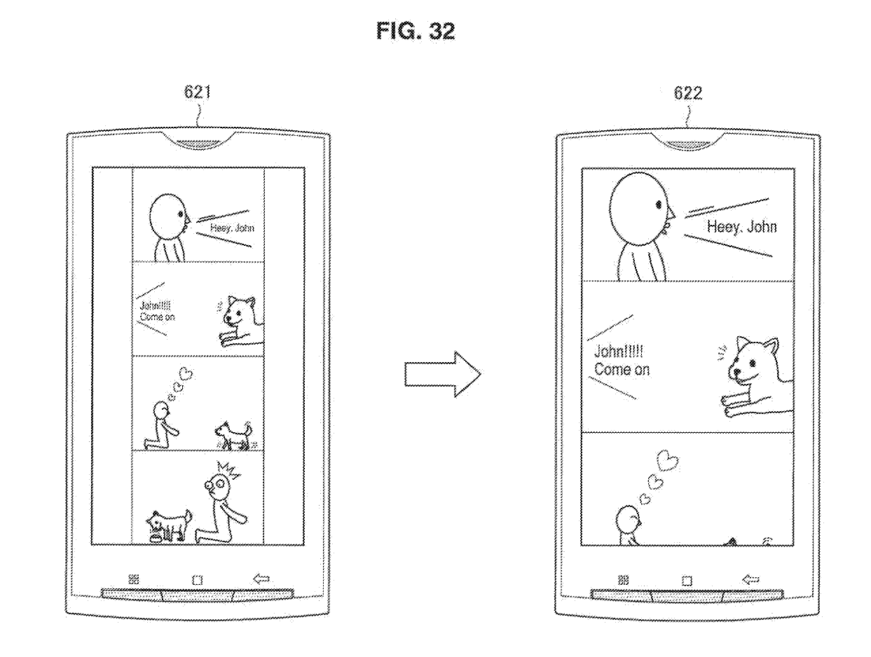

FIG. 32 is a diagram for describing an example of a manipulation method according to the present modified example. The example illustrated in FIG. 32 shows a display picture 621 displaying a whole 4-frame cartoon as it is. For example, when any frame is tapped in a state in which the display picture 621 is displayed, the generation unit 145 may generate a display picture enlarged with the tapped frame as the center. For example, FIG. 32 illustrates an example in which the second frame of the 4-frame cartoon is tapped, and the screen is changed to a display picture 622 in which the second frame has been enlarged.

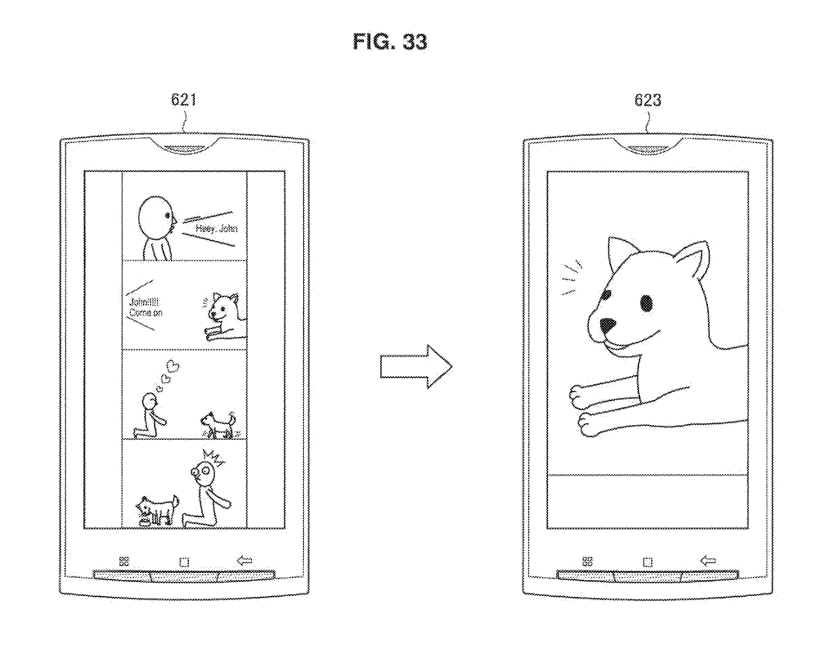

FIG. 33 is a diagram for describing an example of a manipulation method according to the present modified example. The example illustrated in FIG. 33 shows a display picture 621 displaying a whole 4-frame cartoon as it is. For example, when any constituent element (character, background, balloon or the like) is tapped in a state in which the display picture 621 is displayed, the generation unit 145 may generate a display picture enlarged with the tapped constituent element as the center. For example, FIG. 33 illustrates an example in which a character of the second frame of the 4-frame cartoon is tapped, and the screen is changed to a display picture 623 in which the character of the second frame has been enlarged.

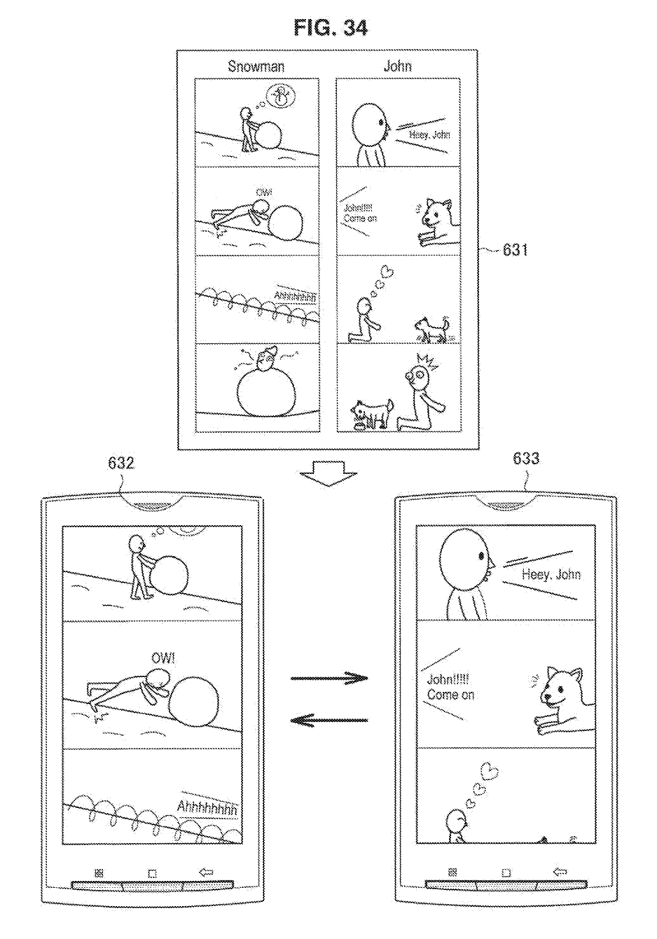

FIG. 34 is a diagram for describing an example of a manipulation method according to the present modified example. In the example illustrated in FIG. 34, content 631 includes two 4-frame cartoons. In this case, the generation unit 145 generates a display picture 632 or a display picture 633 which includes only one of the two cartoons. Also, when a vertical swiping manipulation is performed in a state in which the display picture 632 or 633 is displayed, the generation unit 145 generates a display picture scrolled within the displayed 4-frame cartoon to update the screen. On the other hand, the generation unit 145 generates the display picture 633 to change the screen when swiping to the right is performed in a state in which the display picture 632 is displayed and generates the display picture 632 to change the screen when swiping to the left is performed in a state in which the display picture 633 is displayed. Here, it should be noted that the displayed 4-frame cartoon is switched but not scroll. The generation unit 145 generates a display picture with respect to content before and after the content 631 to change the screen when swiping to the right is performed in a state in which the display picture 632 is displayed or swiping to the right is performed in a state in which the display picture 633 is displayed.

### (1.3) Example of Lyrics Card

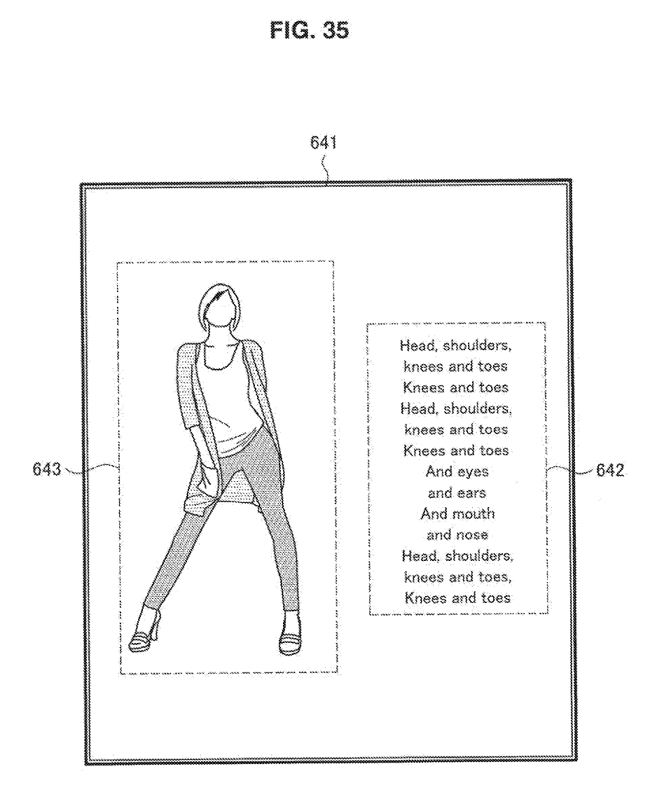

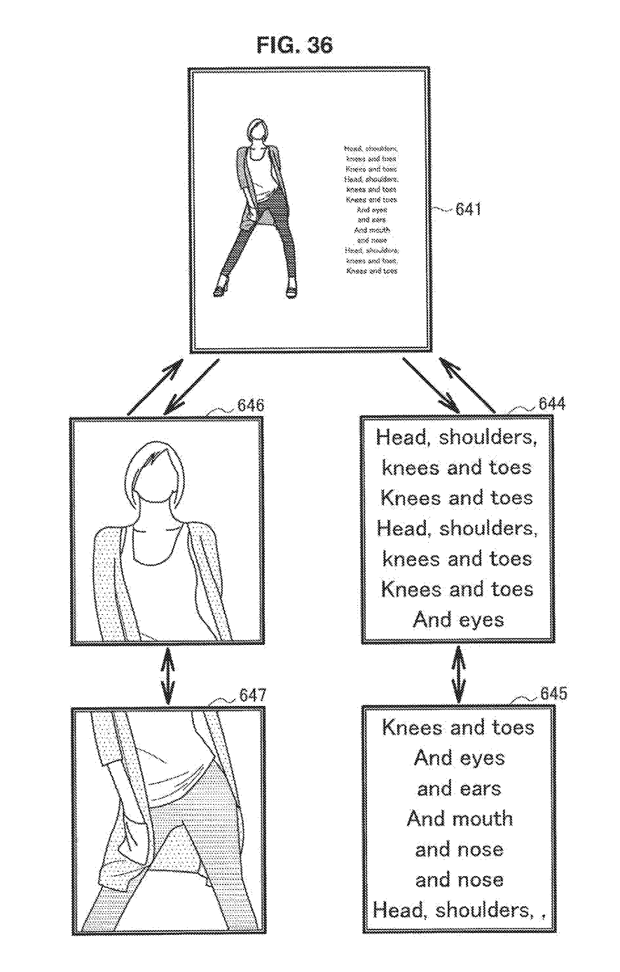

Hereinafter, an example of a manipulation method in a case in which content is a lyrics card will be described with reference to FIGS. 35 and 36.

FIG. 35 is a diagram for describing an example of a manipulation method according to the present modified example. In the example illustrated in FIG. 35, content 641 is a lyrics card. The generation unit 145 may generate a display picture for displaying the content 641 as it is. Also, the generation unit 145 may generate one of a display picture in which a lyrics part 642 has been enlarged and a display picture in which a person part 643 has been enlarged according to the fact that the content 641 is a lyrics card including the lyrics part 642 and the person part 643.

FIG. 36 is a diagram for describing an example of a manipulation method according to the present modified example. FIG. 36 illustrates screen changing between display pictures 644 and 645 in which the lyrics part 642 of the lyrics card 641 illustrated in FIG. 35 has been enlarged and display pictures 646 and 647 in which the person part 643 has been enlarged. For example, when the lyrics part 642 is tapped in a state in which the lyrics card 641 is displayed, the generation unit 145 generates the display picture 644 in which lyrics part 642 has been enlarged to change the screen. Then, when a vertical swiping manipulation is performed in a state in which the display picture 644 is displayed, the generation unit 145 generates the display picture 645 scrolled in the lyrics part 642 to update the screen. On the other hand, when the person part 643 is tapped in a state in which the lyrics card 641 is displayed, for example, the generation unit 145 generates the display picture 646 in which person part 643 has been enlarged to change the screen. Then, when a vertical scroll manipulation is performed in a state in which the display picture 646 is displayed, the generation unit 145 generates the display picture 647 scrolled in the person part 643 to update the screen.

### (1.5) Supplement

Manipulation methods for enlarging and displaying while sequentially changing part of content have been described.

Although examples in which one frame of a cartoon or part thereof is enlarged and displayed have been described above, the present technique is not limited to such examples. For example, a plurality of frames (e.g., one 4-frame cartoon) or page spreads may be collectively enlarged and displayed, and a balloon, a dialogue, stage directions, handwritten characters, a person's face or a whole image of a person may be enlarged and displayed.

Also, although examples in which a face part of a person is enlarged and displayed have been described with respect to photos, the present technique is not limited such examples. For example, a whole image of a person, sports equipment (a ball, a racket, a goal or the like), a landmark (Tokyo Tower or the like) or a red-letter part of a note may be enlarged and displayed. Also, photos may be rearranged for each event to display a list for each event. This is the same for illustrations, for example, in addition to photos.

As another example, in regard to a magazine, for example, each article may be enlarged and displayed and articles may be sequentially changed, and picture parts corresponding to articles may be changed. Also, in regard to crime-prevention pictures captured by a surveillance camera, a number plate part of a vehicle, for example, may be enlarged and displayed. Further, in regard to a floor plan of a house, each room may be enlarged and displayed and rooms may be changed from a room to another room.

### (2) Partial Enlargement/Reduction Depending on Metadata

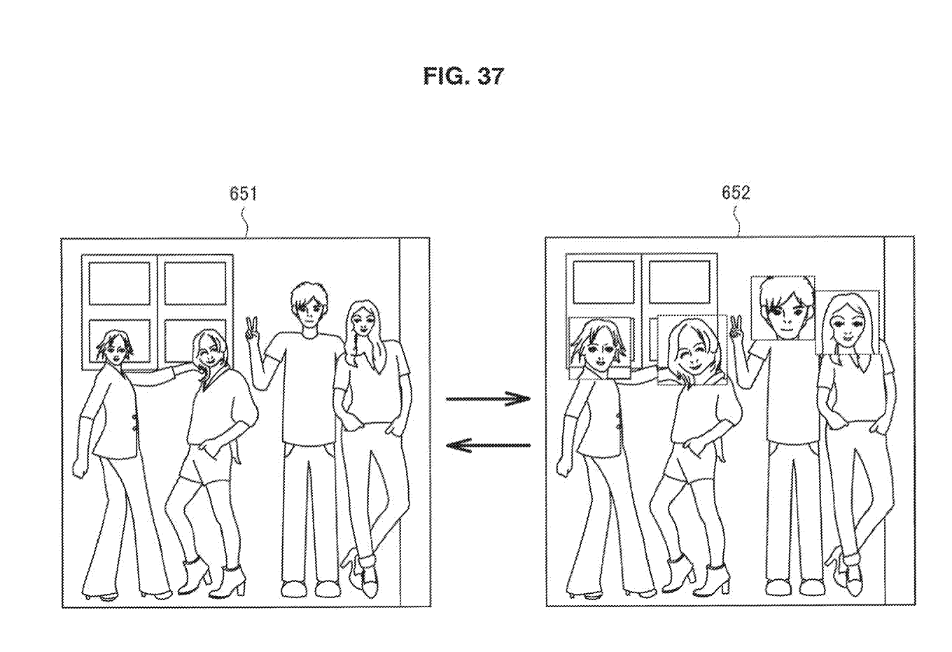

Hereinafter, a manipulation method of enlarging/reducing part of content while displaying a whole image of the content will be described with reference to FIGS. 37 to 42.

FIG. 37 is a diagram for describing an example of the manipulation method according to the present modified example. In the example illustrated in FIG. 37, content 651 is a still picture which is a group photo of people. The generation unit 145 may generate a display picture 651 for displaying the content 651 as it is. Then, when a pinch-out manipulation is performed in a state in which the display picture 651 is displayed, the generation unit 145 may generate a display picture 652 in which face parts of all people included in the group photo have been enlarged to update the screen. Also, when a pinch-in manipulation is performed in a state in which the display picture 652 is displayed, the generation unit 145 may re-generate the display picture 651 in which the enlarged face parts have been returned to the original sizes thereof to update the screen.

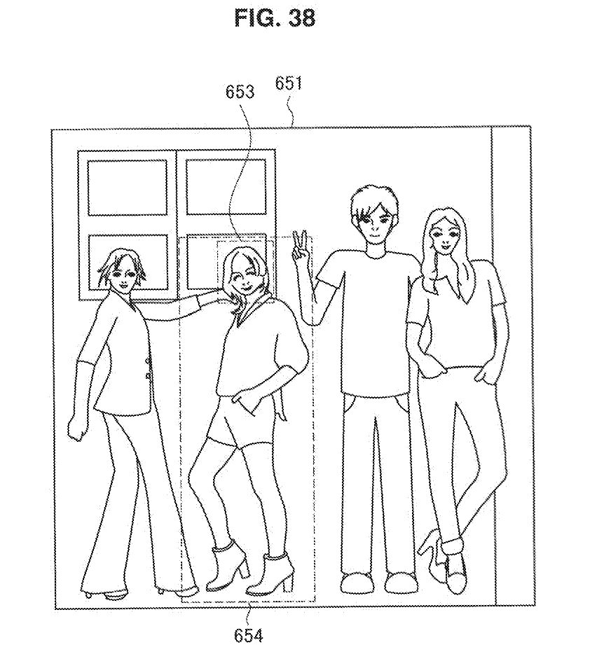

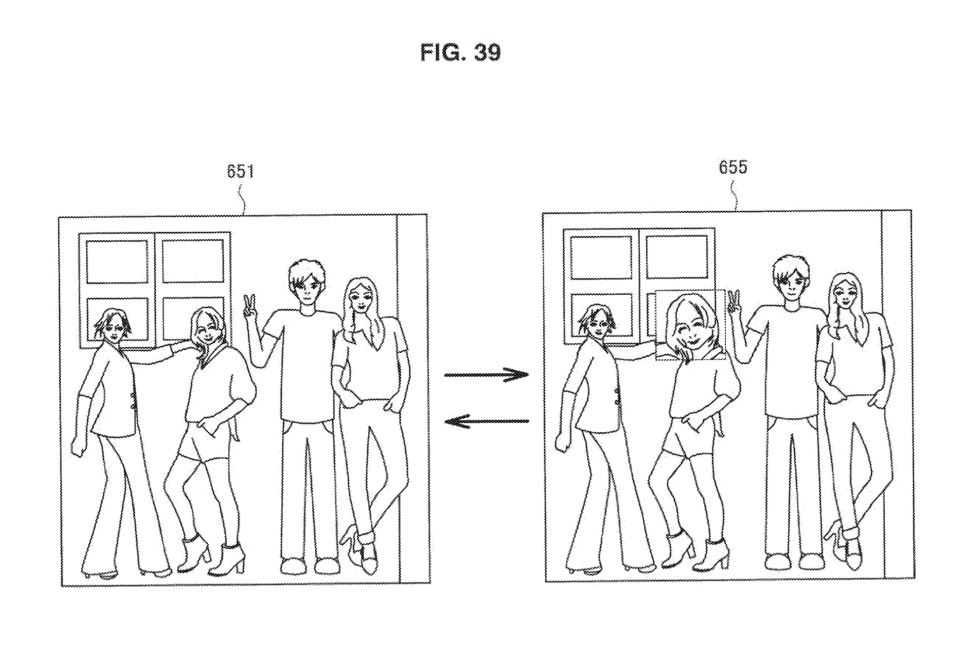

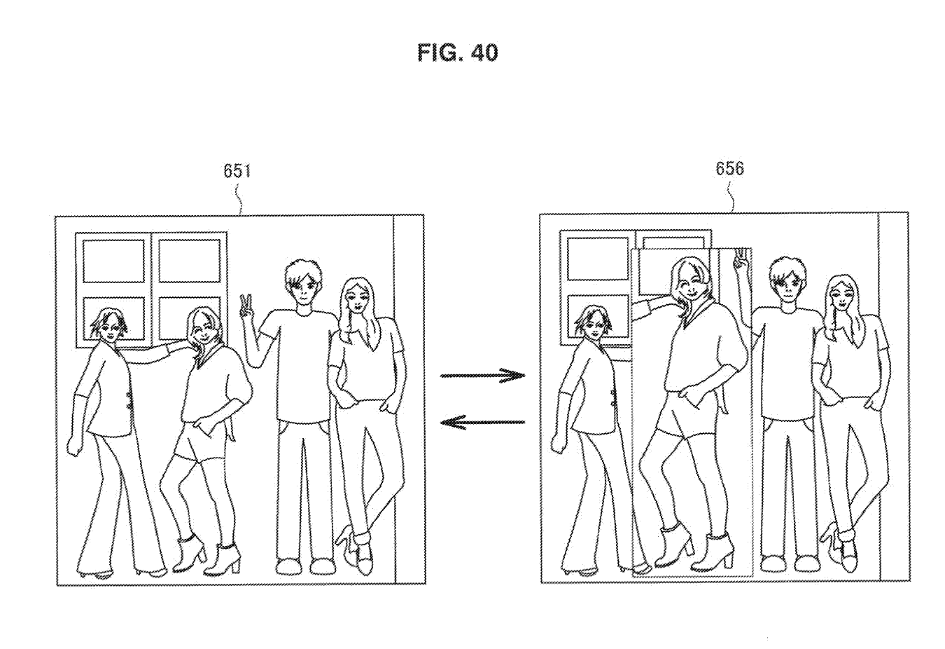

FIGS. 38 to 40 are diagrams for describing an example of the manipulation method according to the present modified example. As illustrated in FIG. 38, the display picture 651 includes a face part 653 and another body part 654 when taking note of one person. For example, when the face part 6543 is tapped in a state in which the display picture 651 is displayed, as illustrated in FIG. 39, the generation unit 145 generates a display picture 655 in which the face part 653 has been enlarged to update the screen. Also, when a part other than the face is tapped in a state in which the display picture 655 is displayed, the generation unit 145 re-generates the display picture 651 in which the enlarged face part has been returned to the original size thereof to update the screen. On the other hand, when the body part 654 is tapped in a state in which the display picture 651 is displayed, as illustrated in FIG. 40, the generation unit 145 generates a display picture 656 in which the whole body including the face has been enlarged to update the picture. Also, when a part other than the body is tapped in a state in which the display picture 656 is displayed, the generation unit 145 re-generates the display picture 651 in which the enlarged body part has been returned to the original size thereof to update the screen.

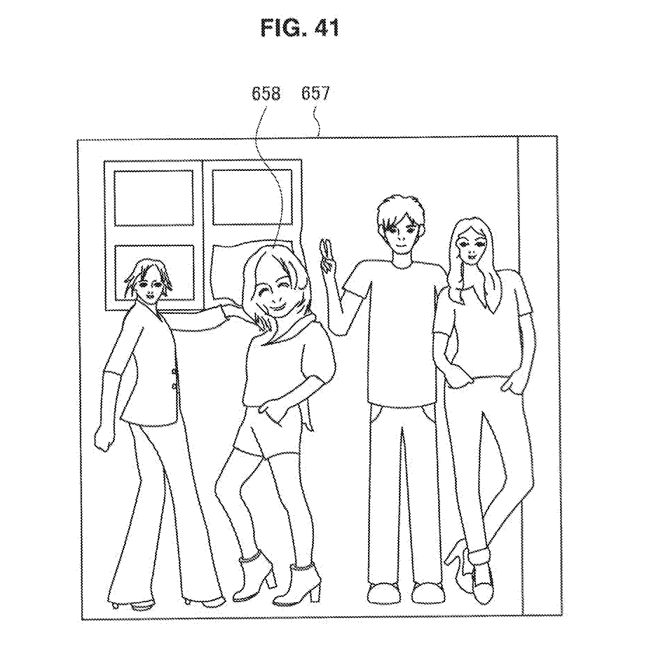

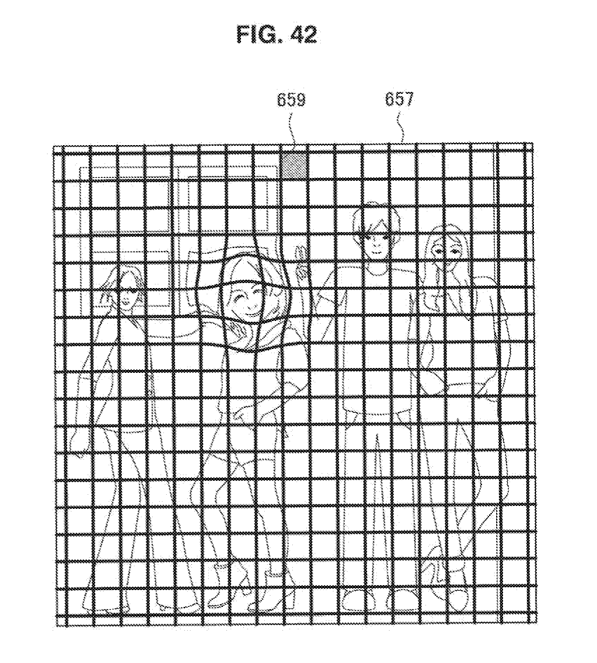

Note that partial enlargement/reduction may be realized according to control of allocation of pixels. For example, partial enlargement may be realized by allocating a large number of pixels to a region to be enlarged and allocating a small number of pixels to other regions. Hereinafter, an example of partial enlargement according to control of allocation of pixels will be described with reference to FIGS. 41 and 42.

FIGS. 41 and 42 are diagrams for describing an example of a manipulation method according to the present modified example. More specifically, FIGS. 41 and 42 are diagrams for describing partial enlargement according to control of allocation of pixels. FIG. 41 shows a display picture 657 in which the face part of a person 658 has been enlarged by allocating a large number of pixels to the face part and allocating a small number of pixels to the region around the face part. FIG. 42 is a diagram conceptually illustrating the number of pixels allocated to each unit region 659 of a picture in the display picture 657 illustrated in FIG. 17. The figure shows that a larger number of pixels are allocated as the unit region 659 becomes larger and a smaller number of pixels are allocated as the unit region 659 becomes smaller. As illustrated in FIG. 18, a large number of pixels are allocated to the face part, whereas a small number of pixels are allocated to the region around the face part. Since the number of allocated pixels continuously changes, the enlarged region appears to be distorted. However, all parts included in the original content are included in the display picture according to such control of allocation of pixels. Accordingly, it is possible to not only improve visibility but also generate a more natural display picture with a high bird's eye view.

### 3) Manipulation Method Depending on Context Information

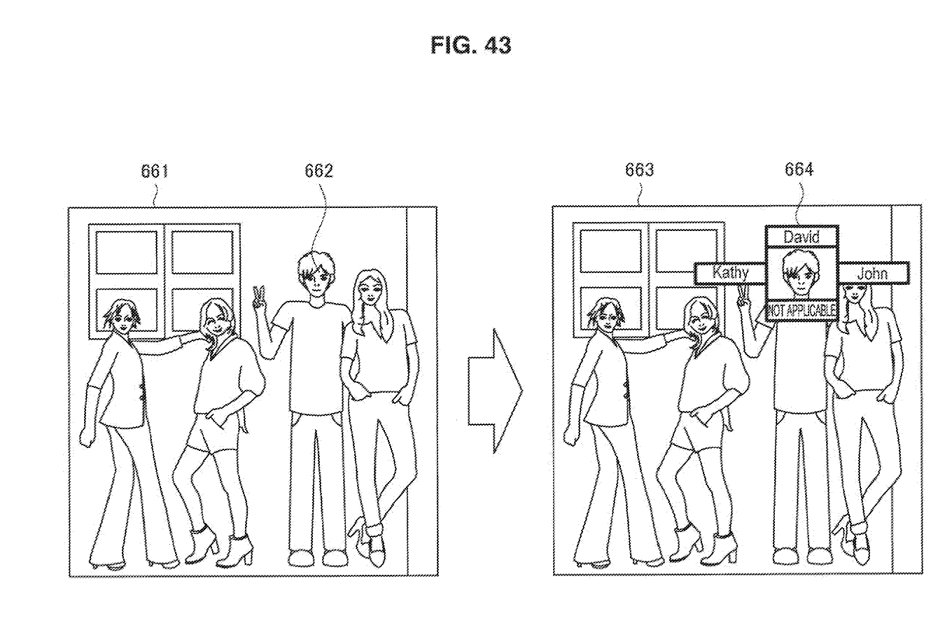

A manipulation method depending on context information may be set. For example, when the purpose of viewing content of persons is different, the manipulation methods may also be different. Hereinafter, an example of a manipulation method depending on the purpose of viewing content will be described with reference to FIG. 43.

FIG. 43 is a diagram for describing an example of the manipulation method according to the present embodiment. In the example illustrated in FIG. 43, content 661 is a still picture which is a group photo of people. The generation unit 145 may generate a display picture 661 for displaying the content 661 as it is. Then, when a face part of a person 662 is tapped in a state in which the display picture 661 is displayed, the generation unit 145 may generate a display picture 663 including tag candidates 664 for inputting a name tag to the person 662 to update the screen. When a finger is placed on the face part of the person 662 in a state in which the display picture 661 is displayed, for example, the generation unit 145 may generate the display picture 663 including the tag candidates 664 for inputting a name tag through a flicking manipulation on the person 662, other than a tap manipulation, to update the screen. At this time, when “not applicable” is selected from the tag candidates 664, the generation unit 145 may generate a display picture including another input interface such as a software keyboard to update the screen.

When the purpose of viewing content is to merely view the content, a face part of a group photo may be enlarged by manipulating the face part, as described above with reference to FIG. 39, for example. In contrast, when the purpose of viewing content is to input a tag, a tag input interface appears according to manipulation of a face part of a group photo, as described above with reference to FIG. 43, for example. In this manner, the manipulation method may be changed depending on the purpose.

Note that switching between the manipulation method for enlargement display based on changing illustrated in FIGS. 27 to 36 and the manipulation method for partial enlargement/reduction based on display of a whole image illustrated in FIGS. 37 to 42 may be performed on the basis of context information such as a screen size. For example, partial enlargement/reduction based on display of a whole image may be performed when the screen size is large enough to secure visibility even when the whole image is displayed, and enlargement display based on changing may be performed when the screen size is not large enough to secure visibility when the whole image is displayed. In regard to content including characters such as a cartoon, the information processing apparatus 100 may read out characters using audio without enlargement when the screen size is too small to secure visibility even when the content is enlarged to full screen size.

### 5. Example of Hardware Configuration

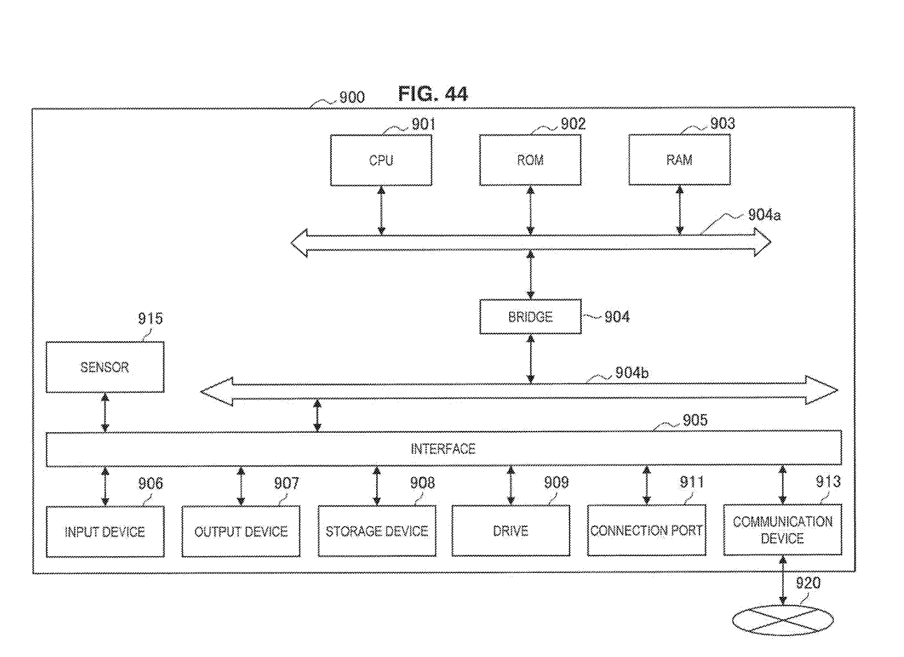

Finally, a hardware configuration of an information processing apparatus according to the present embodiment will be described with reference to FIG. 44. FIG. 44 is a block diagram illustrating an example of the hardware configuration of the information processing apparatus according to the present embodiment. Meanwhile, the information processing apparatus 900 illustrated in FIG. 44 may realize the information processing apparatus 100 illustrated in FIG. 2, for example. Information processing by the information processing apparatus 100 according to the present embodiment is realized according to cooperation between software and hardware described below.

As illustrated in FIG. 44, the information processing apparatus 900 includes a central processing unit (CPU) 901, a read only memory (ROM) 902, a random access memory (RAM) 903 and a host bus 904a. In addition, the information processing apparatus 900 includes a bridge 904, an external bus 904b, an interface 905, an input device 906, an output device 907, a storage device 908, a drive 909, a connection port 911, a communication device 913 and a sensor 915. The information processing apparatus 900 may include a processing circuit such as a DSP or an ASIC instead of the CPU 901 or along therewith.

The CPU 901 functions as an arithmetic processing device and a control device and controls the overall operation in the information processing apparatus 900 according to various programs. Further, the CPU 901 may be a microprocessor. The ROM 902 stores programs used by the CPU 901, operation parameters and the like. The RAM 903 temporarily stores programs used in execution of the CPU 901, parameters appropriately changed in the execution, and the like. The CPU 901 may form the controller 140 illustrated in FIG. 4, for example.

The CPU 901, the ROM 902 and the RAM 903 are connected by the host bus 904a including a CPU bus and the like. The host bus 904a is connected with the external bus 904b such as a peripheral component interconnect/interface (PCI) bus via the bridge 904. Further, the host bus 904a, the bridge 904 and the external bus 904b are not necessarily separately configured and such functions may be mounted in a single bus.

The input device 906 is realized by a device through which a user inputs information, for example, a mouse, a keyboard, a touch panel, a button, a microphone, a switch, a lever of the like. In addition, the input device 906 may be a remote control device using infrared ray or other electric waves or external connection equipment such as a cellular phone or a PDA corresponding to manipulation of the information processing apparatus 900, for example. Furthermore, the input device 906 may include an input control circuit or the like which generates an input signal on the basis of information input by the user using the aforementioned input means and outputs the input signal to the CPU 901, for example. The user of the information processing apparatus 900 may input various types of data or order a processing operation for the information processing apparatus 900 by manipulating the input device 906. The input device 906 may form the input unit 110 illustrated in FIG. 2, for example.

The output device 907 is formed by a device that may visually or aurally notify the user of acquired information. As such devices, there is a display device such as a CRT display device, a liquid crystal display device, a plasma display device, an EL display device or a lamp, a sound output device such as a speaker and a headphone, a printer device and the like. The output device 907 outputs results acquired through various processes performed by the information processing apparatus 900, for example. Specifically, the display device visually displays results acquired through various processes performed by the information processing apparatus 900 in various forms such as text, images, tables and graphs. On the other hand, the sound output device converts audio signals composed of reproduced sound data, audio data and the like into analog signals and aurally outputs the analog signals. The aforementioned display device may form the display unit 120 illustrated in FIG. 2, for example. The sound output device may output BGM or the like, for example, when the display unit 120 illustrated in FIG. 22 displays a display picture.

The storage device 908 is a device for data storage, formed as an example of a storage unit of the information processing apparatus 900. For example, the storage device 908 is realized by a magnetic storage device such as an HDD, a semiconductor storage device, an optical storage device, a magneto-optical storage device or the like. The storage device 908 may include a storage medium, a recording medium recording data on the storage medium, a reading device for reading data from the storage medium, a deletion device for deleting data recorded on the storage medium and the like. The storage device 908 stores programs and various types of data executed by the CPU 901, various types of data acquired from the outside and the like. The storage device 908 may form the storage unit 130 illustrated in FIG. 2, for example.

The drive 909 is a reader/writer for storage media and is included in or externally attached to the information processing apparatus 900. The drive 909 reads information recorded on a removable storage medium such as a magnetic disc, an optical disc, a magneto-optical disc or a semiconductor memory mounted thereon and outputs the information to the RAM 903. In addition, the drive 909 can write information on the removable storage medium.

The connection port 911 is an interface connected with external equipment and is a connector to the external equipment through which data may be transmitted through a universal serial bus (USB) and the like, for example. The connection port 911 can form the input unit 114 illustrated in FIG. 2, for example.

The communication device 913 is a communication interface formed by a communication device for connection to a network 920 or the like, for example. The communication device 913 is a communication card or the like for a wired or wireless local area network (LAN), long term evolution (LTE), Bluetooth (registered trademark) or wireless USB (WUSB), for example. In addition, the communication device 913 may be a router for optical communication, a router for asymmetric digital subscriber line (ADSL), various communication modems or the like. For example, the communication device 913 may transmit/receive signals and the like to/from the Internet and other communication apparatuses according to a predetermined protocol, for example, TCP/IP or the like. The communication device 913 may form the input unit 110 illustrated in FIG. 2, for example.

Further, the network 920 is a wired or wireless transmission path of information transmitted from devices connected to the network 920. For example, the network 920 may include a public circuit network such as the Internet, a telephone circuit network or a satellite communication network, various local area networks (LANs) including Ethernet (registered trademark), a wide area network (WAN) and the like. In addition, the network 920 may include a dedicated circuit network such as an internet protocol-virtual private network (IP-VPN).

The sensor 915 is various sensors such as an acceleration sensor, a gyro sensor, a geomagnetic sensor, an optical sensor, a sound sensor, a ranging sensor and a force sensor. The sensor 915 acquires information about the state of the information processing apparatus 900 such as the posture and moving speed of the information processing apparatus 900 and information about a surrounding environment of the information processing apparatus 900 such as surrounding brightness and noise of the information processing apparatus 900. In addition, the sensor 915 may include a GPS sensor for receiving a GPS signal and measuring the latitude, longitude and altitude of the apparatus. The sensor 915 can form the input unit 110 illustrated in FIG. 2, for example.

Hereinbefore, an example of a hardware configuration capable of realizing the functions of the information processing apparatus 900 according to this embodiment is shown. The respective components may be implemented using universal members, or may be implemented by hardware specific to the functions of the respective components. Accordingly, according to a technical level at the time when the embodiments are executed, it is possible to appropriately change hardware configurations to be used.

In addition, a computer program for realizing each of the functions of the information processing apparatus 900 according to the present embodiment may be created, and may be mounted in a PC or the like. Furthermore, a computer-readable recording medium on which such a computer program is stored may be provided. The recording medium is a magnetic disc, an optical disc, a magneto-optical disc, a flash memory, or the like, for example. In addition, the computer program may be delivered through a network, for example, without using the recording medium.

### 6. Conclusion

An embodiment of the present disclosure has been described in detail with reference to FIGS. 1 to 44. As described above, the information processing apparatus 100 according to the present embodiment generates a display picture depending on the details of input content and information indicating a relationship between the content and a user. Accordingly, the information processing apparatus 100 can control display of the content itself based on the relationship between the content and the user. More specifically, the user can view a display picture adapted to a context such as his/her preference, knowledge, actions or surrounding environment, and thus user convenience is improved.

Also, the information processing apparatus 100 according to the present embodiment generates a display picture in which at least one of objects included in content has been emphasized or blurred depending on the details of the content and the information indicating the relationship. Accordingly, the user can easily see a part that the user needs to see. Also, the user need not pay attention to a part that the user need not see and thus can focus on the part that the user needs to see.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Meanwhile, devices described in the specification may be realized as independents devices or part of or all devices may be realized as separate devices. For example, in the example of the functional configuration of the information processing apparatus 100 illustrated in FIG. 2, the storage unit 130 and the controller 140 may be included in a device such as a server connected to the input unit 110 and the display unit 120 through a network or the like.

Note that it is not necessary for the processing described in this specification with reference to the flowchart to be executed in the order shown in the flowchart. Some processing steps may be performed in parallel. Further, some of additional steps can be adopted, or some processing steps can be omitted.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1)

An information processing apparatus including:

a display control unit that controls display of acquired content depending on the acquired content, metadata of the content, and information indicating a relationship between the content and a user.

(2)

The information processing apparatus according to (1),

in which the display control unit changes a display form of the content or changes some or all objects included in the content.

(3)

The information processing apparatus according to (2),

in which the display control unit emphasizes or blurs at least one of objects included in the content.

(4)

The information processing apparatus according to (3),

in which the display control unit allocates the number of pixels to each of the objects depending on the content, the metadata and the information indicating the relationship.

(5)

The information processing apparatus according to (3) or (4),

in which the display control unit converts notation included in the content into notation with improved visibility.

(6)

The information processing apparatus according to any one of (3) to (5),

in which the display control unit changes a disposition of the objects.

(7)

The information processing apparatus according to any one of (1) to (6), further including a setting unit that respectively sets a priority to the information indicating the relationship.

(8)

The information processing apparatus according to any one of (1) to (7),

in which the information indicating the relationship includes information related to a property of the user.

(9)

The information processing apparatus according to any one of (1) to (8),

in which the information indicating the relationship includes information related to knowledge or preference of the user with respect to the content.

(10)

The information processing apparatus according to any one of (1) to (9),

in which the information indicating the relationship includes information related to a purpose of the user viewing the content.

(11)

The information processing apparatus according to any one of (1) to (10),

in which the information indicating the relationship includes information related to a region of interest of the user in a display picture displayed through control by the display control unit.

(12)

The information processing apparatus according to any one of (1) to (11),

in which the information indicating the relationship includes sound information based on viewing of a display picture displayed through control by the display control unit.

(13)

The information processing apparatus according to any one of (1) to (12),

in which the information indicating the relationship includes action information based on viewing of a display picture displayed through control by the display control unit.

(14)

The information processing apparatus according to any one of (1) to (13),

in which the information indicating the relationship includes information related to a positional relationship between the user and a display unit that displays a display picture displayed through control by the display control unit.

(15)

The information processing apparatus according to any one of (1) to (14),

in which the information indicating the relationship includes information indicating a characteristic related to a display unit that displays a display picture displayed through control by the display control unit.

(16)

The information processing apparatus according to any one of (1) to (15),

in which the information indicating the relationship includes information related to an environment of the user.

(17)

The information processing apparatus according to any one of (1) to (16),

in which the display control unit sets a manipulation method for the displayed content depending on the metadata.

(18)

The information processing apparatus according to any one of (1) to (17),

in which the display control unit sets a manipulation method for the displayed content depending on the information indicating the relationship.

(19)

A picture processing method including:

controlling display of acquired content by a processor, depending on the acquired content, metadata of the content, and information indicating a relationship between the content and a user.

(20)

A program for causing a computer to function as

a display control unit that controls display of acquired content depending on the content, metadata of the content, and information indicating a relationship between the content and a user.

### REFERENCE SIGNS LIST

100 information processing apparatus

110 input unit

120 display unit

130 storage unit

140 controller

141 content acquisition unit

143 context determination unit

145 generation unit

147 setting unit

149 display control unit

1. An information processing apparatus comprising:
a display control unit that controls display of acquired content depending on the acquired content, metadata of the content, and information indicating a relationship between the content and a user.

2. The information processing apparatus according to claim 1,
wherein the display control unit changes a display form of the content or changes some or all objects included in the content.

3. The information processing apparatus according to claim 2,
wherein the display control unit emphasizes or blurs at least one of objects included in the content.

4. The information processing apparatus according to claim 3,
wherein the display control unit allocates the number of pixels to each of the objects depending on the content, the metadata and the information indicating the relationship.

5. The information processing apparatus according to claim 3,
wherein the display control unit converts notation included in the content into notation with improved visibility.

6. The information processing apparatus according to claim 3,
wherein the display control unit changes a disposition of the objects.

7. The information processing apparatus according to claim 1, further comprising a setting unit that respectively sets a priority to the information indicating the relationship.

8. The information processing apparatus according to claim 1,
wherein the information indicating the relationship includes information related to a property of the user.

9. The information processing apparatus according to claim 1,
wherein the information indicating the relationship includes information related to knowledge or preference of the user with respect to the content.

10. The information processing apparatus according to claim 1,
wherein the information indicating the relationship includes information related to a purpose of the user viewing the content.

11. The information processing apparatus according to claim 1,
wherein the information indicating the relationship includes information related to a region of interest of the user in a display picture displayed through control by the display control unit.

12. The information processing apparatus according to claim 1,
wherein the information indicating the relationship includes sound information based on viewing of a display picture displayed through control by the display control unit.

13. The information processing apparatus according to claim 1,
wherein the information indicating the relationship includes action information based on viewing of a display picture displayed through control by the display control unit.

14. The information processing apparatus according to claim 1,
wherein the information indicating the relationship includes information related to a positional relationship between the user and a display unit that displays a display picture displayed through control by the display control unit.

15. The information processing apparatus according to claim 1,
wherein the information indicating the relationship includes information indicating a characteristic related to a display unit that displays a display picture displayed through control by the display control unit.

16. The information processing apparatus according to claim 1,
wherein the information indicating the relationship includes information related to an environment of the user.

17. The information processing apparatus according to claim 1,
wherein the display control unit sets a manipulation method for the displayed content depending on the metadata.

18. The information processing apparatus according to claim 1,
wherein the display control unit sets a manipulation method for the displayed content depending on the information indicating the relationship.

19. A picture processing method comprising:
controlling display of acquired content by a processor, depending on the acquired content, metadata of the content, and information indicating a relationship between the content and a user.

20. A program for causing a computer to function as
a display control unit that controls display of acquired content depending on the content, metadata of the content, and information indicating a relationship between the content and a user.
